(19) United States
(12) Patent Application Publication
(10) Pub. No.: US 2014/0089017 A1
(43) Pub. Date: Mar. 27, 2014

(54) SYSTEMS AND METHODS FOR OPERATING AN ENTERTAINMENT CONTROL SYSTEM

(71) Applicant: UNITED VIDEO PROPERTIES, INC., Santa Clara, CA (US)

(72) Inventors: Walter R. Klappert, Los Angeles, CA (US); Satinderpal S. Sikh, Studio City, CA (US); Michael R. Nichols, La Canada Flintridge, CA (US)

(73) Assignee: UNITED VIDEO PROPERTIES, INC., Santa Clara, CA (US)

(21) Appl. No.: 13/629,177

(22) Filed: Sep. 27, 2012

(51) Int. Cl. G06Q 10/02

(52) U.S. Cl. CPC G06Q 10/02
USPC 705/5

(57) ABSTRACT

Methods and systems are described herein for allocating and assigning seats within a venue, based on user profile information. A cluster of user profiles is selected based on a correlation of values of a common attribute of the user profiles. Seats within the venue are allocated to a first zone based on the correlation, and are assigned to users associated with the user profiles.

### BACKGROUND OF THE DISCLOSURE

Media content is viewable in a variety of venues. Electronic media guide applications may be used to navigate the multitude of media guidance information that corresponds to the viewable media content. Current venues are deficient in the assignment of seats. Seats in the venue are typically reserved on a first come-first served basis, either upon arrival at the venue, or in advance of attending the venue. There is no ability to group seating assignments by the interests and demographic information of users. For example, single viewers seeking to meet other viewers may be seated next to families instead of other single viewers. Such seating assignments may be deficient, as users having different interests may interfere and hinder each other's viewing experience, rather than mutually enhancing the experience. A plurality of user profile information, containing information such as demographic information and interests, may be used to allocate and assign seating within a venue that presents media content.

### SUMMARY OF THE DISCLOSURE

In view of the foregoing, systems and methods are provided for creating a seating arrangement in a venue having a plurality of seats. In particular, information from various user profiles corresponding to different services may be used to allocate seating zones within the venue, and subsequently assign seating with the zones.

In some embodiments, a plurality of user profiles may be retrieved for users attending a venue together. It may be determined which of the retrieved profiles have a common attribute. The common attribute values of the user profiles that include the common attribute may be correlated. Based on the correlation of the common attribute values, a first cluster of the user profiles may be selected. In some implementations, the common attribute may be one of viewing preferences, demographic information such as age, gender, race, profession, marital status, or a number of dependents.

In some embodiments, a first number of seats in a venue having a proximal relationship may be allocated. The number of allocated seats may correspond to number of user profiles in the first selected cluster. A remaining number of seats in the venue may be allocated to a second seating zone. In some implementations, the assigning of the seats in the first seating zone may be done automatically.

In some embodiments, a visual representation of the first and second seating zones may be generated for display to user. A user request for a seating assignment may be received. In response to receiving the user request, it may be determined whether a user profile associated with the requesting user corresponds to the first zone. If the user profile corresponding to the user corresponds to the first zone, the seating assignment of the user may be restricted to the first seating zone.

In some embodiments, user profile information may be retrieved for a user that is not in the plurality of retrieved user profiles. A user profile may be retrieved that is distinct from the retrieved plurality of user profiles that include the common attribute. It may be determined whether the distinct user profile includes the common attribute. In response to determining that the distinct user profile includes the common attribute, the common attribute value of the distinct user profile may be correlated to the common attribute values of the plurality of user profiles that include the common attribute. Based on the correlation, the distinct user profile may be added to the selected cluster of user profiles. A seat may be assigned to a user associated with the distinct user profile, which is in the first seating zone or adjacent to the first seating zone. The number of allocated seats for the first seating zone may be adjusted based on the correlation of the common attribute value of the distinct user profile and the common attribute values of the plurality of user profiles.

In some embodiments, the venue may be a theatre for presenting a common media asset to a plurality of users seated in the venue. Each of the user profiles may include patron information about an associated user, and a common attribute may include patron information. The assignment of a seat may be based on the patron information. In some embodiments, the venue may be a transportation craft.

In some embodiments, each seat within the venue may include a viewing apparatus. Each user profile may include viewer preference information such as parental control information, favorite actor, favorite genre, favorite title, favorite director, or favorite character. The common attribute may include viewer preference information and the first seating zone may be associated with viewer preference information of users. A request may be received from a user for a seating assignment. In response to receiving the request, it may be determined whether viewer preference information corresponding to the requesting user corresponds to the common attribute. In response to the determination, the assignment of the seat to the user may be restricted to the first seating zone. In some implementations, each user profile is a media guidance application user profile. In some implementations, a media asset for display in the first seating zone may be determined based on the common attribute of the cluster of user profiles corresponding to the first seating zone.

### BRIEF DESCRIPTION OF THE DRAWINGS

FIG. 1 shows an illustrative interactive media guidance application display screen in accordance with some embodiments of the present disclosure;

FIG. 2 shows another illustrative interactive media guidance application display screen in accordance with some embodiments of the present disclosure;

FIG. 3 illustrates an example of a user device that may provide media assets in accordance with some embodiments of the present disclosure;

FIG. 4 illustrates an example of a system that provides media assets in accordance with some embodiments of the present disclosure;

FIG. 5 shows an illustrative interactive media guidance application display screen that includes information about different seating zones and attributes associated with the different seating zones in some embodiments of the present disclosure;

FIG. 6 shows an illustrative interactive media guidance application display screen that includes user profile information such as personal information and user viewing habits in some embodiments of the present disclosure;

FIG. 7 shows an illustrative display screen that includes user profile information associated with a venue or service in some embodiments of the present disclosure;

FIG. 8 shows an illustrative display screen that includes detailed information about a seating zone and users assigned to the seating zone in some embodiments of the present disclosure;

FIG. 9 shows an illustrative display screen that includes detailed information about users assigned to a seating zone in some embodiments of the present disclosure;

FIG. 10 shows an illustrative display screen that includes information about media content that may be viewed in a venue in some embodiments of the present disclosure;

FIG. 11 shows an illustrative display screen that includes information about a user and a user device in a viewing venue in some embodiments of the present disclosure;

FIG. 12 shows an illustrative display screen that shows media content that may be viewed in some embodiments of the present disclosure;

FIG. 13 shows an illustrative display screen that shows interactive user activities that may take place in the viewing venue in accordance with some embodiments of the present disclosure;

FIG. 14 illustrates a flowchart of steps that may be implemented by a system for allocating seating zones and assigning seats within seating zones in some embodiments of the present disclosure;

FIG. 15 illustrates a flowchart of steps that may be implemented by a system for allocating seating zones and assigning seats within seating zones according to user profile information in some embodiments of the present disclosure;

FIG. 16 illustrates a flowchart of steps that may be implemented by a system for renting viewing equipment in a venue in some embodiments of the present disclosure; and

FIG. 17 illustrates a flowchart of steps that may be performed by a system for holding auction activities in a viewing venue in some embodiments of the present disclosure.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance. Such guidance applications are supported by databases and web servers capable of storing and organizing a large amount of media content information from various media content sources and media guidance data sources.

With the advent of the Internet, mobile computing, and high-speed wireless networks, users are accessing media on user equipment devices on which they traditionally did not. As referred to herein, the phrase “computer equipment,” “user equipment device,” “personal user device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a website), or as stand-alone applications or clients on user equipment devices. Various devices and platforms that may implement media guidance applications are described in more detail below.

Users are able to access media content in various venues. As referred to herein, the word “venue” should be understood to mean any location for accessing the content described above together with other users, such as a movie theatre, concert hall, auditorium, stadium or transportation craft.

One of the functions of the media guidance application is to provide media guidance data to users. As referred to herein, the phrase, “media guidance data,” “guidance information” or “guidance data” should be understood to mean any data related to content, such as media listings, media-related information (e.g., content attributes such as broadcast times, broadcast channels, titles, descriptions, ratings information (e.g., parental control ratings, critic's ratings, etc.), genre or category information, actor information, logo data for broadcasters' or providers' logos, metadata tags, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections. As referred to herein, the phrase, “media application parameters” should be understood to mean data used in operating the guidance application or management, such as program information, guidance application settings, user preferences, or user profile information.

A user typically has multiple user profiles, each for a different service. Each user profile includes information about how the service is used by the user. For example, a user may have a user profile with a media guidance application, a user profile with a movie theatre, and a user profile with an airline. The media guidance application user profile may include information about actors of the favorite programs watched by a user. The movie theatre profile may include information about the genres of movies most frequently watched by a user, and preferred seating information about a user. The airline user profile may include information about favorite seating selections of a user. It is possible to collectively combine information from various user profiles to enhance a user's consumption of services. For example, airplane seating may be assigned to passengers based on their seating preferences and media content preferences. This intelligent assignment of seating enhances the travel experience, as people with similar interests are seated near each other, and can view similar media content together.

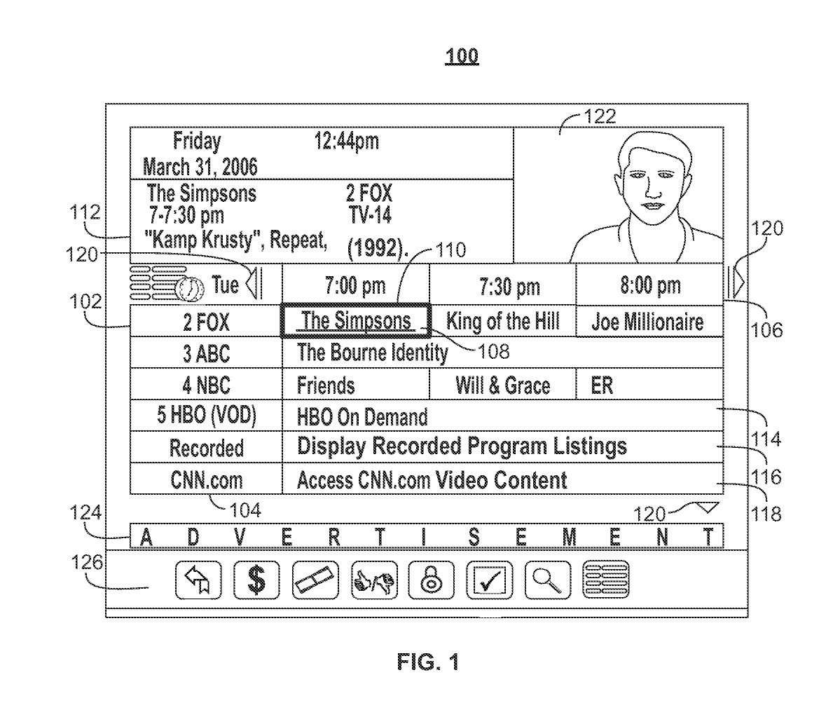

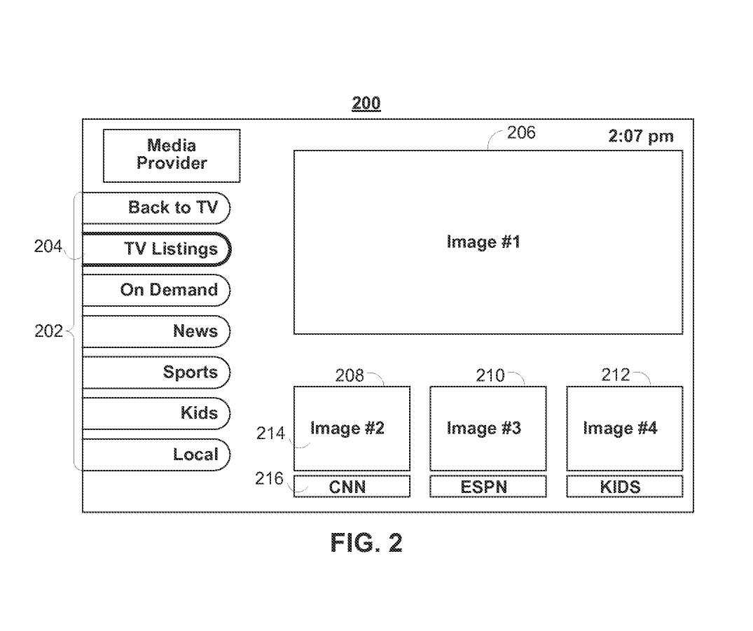

FIGS. 1-2 show illustrative display screens that may be used to provide media guidance data. The display screens shown in FIGS. 1-2 and 5-13 may be implemented on any suitable user equipment device or platform. While the displays of FIGS. 1-2 and 5-13 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by media application parameters.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include Web events, such as a chat session or Webcast, or content available on-demand as streaming content or downloadable content through an Internet website or other Internet access (e.g. FTP).

A program listing 108 may be selected to access detailed media application parameters about a media asset, in addition to the information displayed in program information region 112. The detailed media application parameters may be displayed in program information region 112, in a full-screen display, or as an overlay display that may obscure, in part or completely, media application data screens of FIG. 1.

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a manner similar to selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other airtimes or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, options to select a seating assignment, options to share media content from a personal user device, options to participate in interactive activities, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

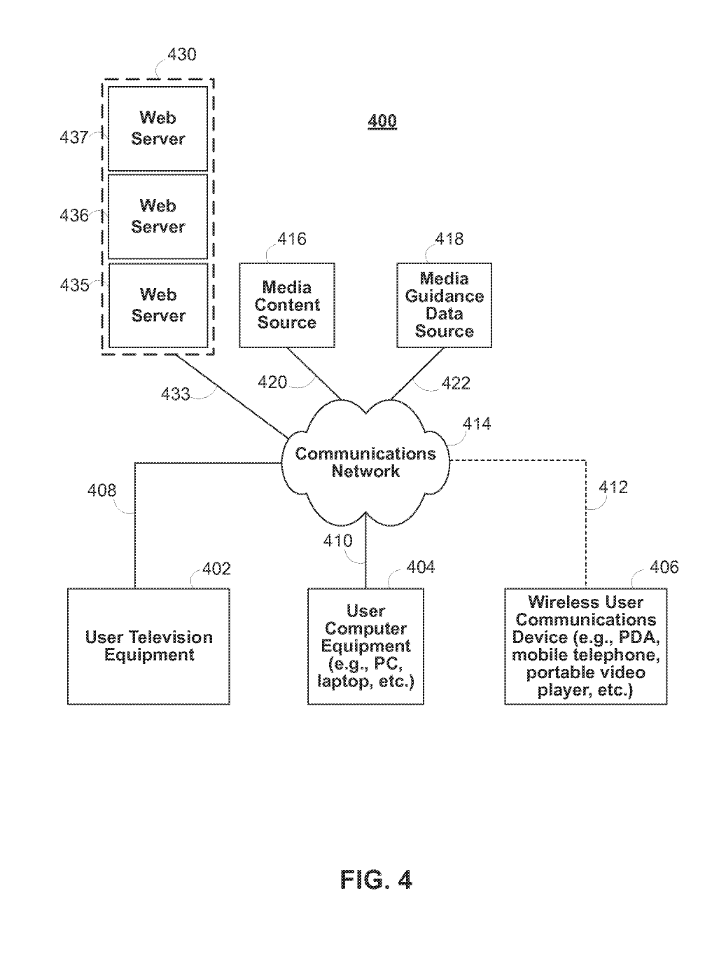

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

The listings of display screen 200 may be selected to access detailed media application parameters about a media asset in a similar fashion as described above in reference to program listing 108. In response to selection of a listing, a detailed guidance information screen may be shown in a full-screen display or as an overlay display.

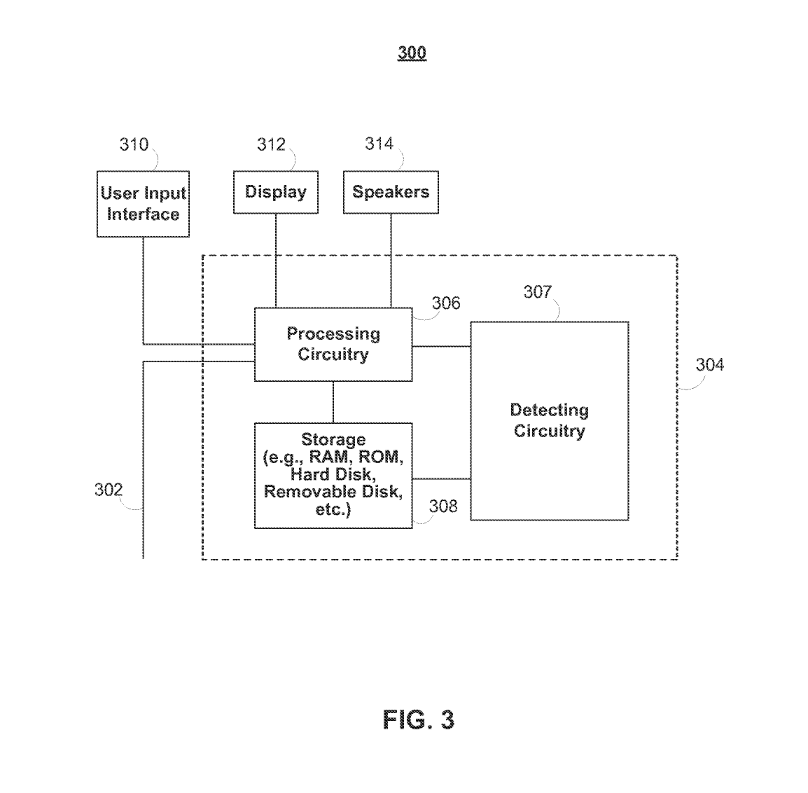

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. The illustrative user equipment device 300 may be used to implement media management applications that are used by administrators. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306, detecting circuitry 307, and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean any circuitry; for example, circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units; for example, multiples of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

In some embodiments, control circuitry 304 may compute correlations across different data values, in order to cluster and organize the data. For example, control circuitry 304 may use k-means clustering to iteratively divide a series of data values into different clusters. Other clustering algorithms such as tree clustering, two-way joining clustering, and expectation maximization clustering may be performed by control circuitry 304 in order to cluster the data.

In some embodiments, control circuitry 304 may include detecting circuitry 307 which may be capable of detecting and/or identifying a user or users without requiring the user or users to make any affirmative actions by using any suitable biometric recognition technique, such as, facial recognition, heat signature recognition, odor recognition, scent recognition, body shape recognition, voice recognition, behavioral recognition, or any other suitable biometric recognition technique. For example, detecting circuitry 307 may detect and identify users using these techniques while the users are within a tangible distance to a media device. In some embodiments, users may be detected and/or identified using any other suitable biometric recognition technique that may in some embodiments require the users to be within a tangible distance to a media device, for example, iris recognition, retinal recognition, palm recognition, finger print recognition, or any other suitable technique.

Detecting circuitry 307, by using wireless techniques, may also be capable of detecting and/or identifying a user or users based on recognition and/or identification of a media device (e.g., a mobile device, such as an RFID device or mobile phone) that may be associated with the user or users. Detecting circuitry 307 may recognize and identify such a device using any suitable means, for example, radio-frequency identification, Bluetooth, Wi-Fi, WiMax, internet protocol, infrared signals, any other suitable IEEE, industrial, or proprietary communication standards, or any other suitable electronic, optical, or auditory communication means. For example, detecting circuitry 307 may determine that a user is within a predetermined detection region of a media device, identify the user, and add the user to a list of active users at the media device. The detection and identification of users as described herein does not require any affirmative action on the part of the user beyond, in some embodiments, the configuration of such methods and systems. For example, any detection and identification of users is done automatically by media devices.

Detecting circuitry 307 may include any suitable hardware and/or software to perform detection and identification operations. For example, detecting circuitry 307 may include infrared, optical, audio and/or radio-frequency receivers and/or transmitters. Detecting circuitry 307 may additionally, or alternatively, include one or more microphone and/or camera to detect audible and/or visual information, respectively. The microphone may be capable of receiving sounds within the audible range and/or outside the audible range. The camera may be capable of capturing information within the visual spectrum and/or outside the visual spectrum. For example, the camera may be able to capture infrared information, ultraviolet information, or any other suitable type of information. Detecting circuitry 307 may additionally, or alternatively, include palm, fingerprint, and/or retinal readers for detecting and/or identifying users. In some embodiments, detecting circuitry may communicate to processing circuitry 306 and/or storage 308 various detection and/or identification mechanisms indicating whether a user is detected and/or identified at a particular device.

For example, using an infrared camera and light source, processing circuitry 306 may generate a three dimensional map of an area. Based on the three dimensional map, control circuitry 304 may detect and identify distinct bodies of users and determine distance of the body from the biometric device. Using color cameras and face detection, control circuitry 304 may detect or identify users. Using microphones and voice recognition, control circuitry 304 may detect or identify users based on the physical characteristics of their vocal tract through voice recognition or identification. Using a sound source and an array of microphones, control circuitry 304 may determine information about the shape of the area surrounding the biometric device. It should be understood that various biometric techniques and devices may be used alone, or in combination to supplement each other to more accurately identify or detect users.

In some embodiments, detecting circuitry 307 may use any suitable method to determine the distance, trajectory, and/or location a user is at in relation to a media device. For example, a media device may use received signal strength indication (RSSI) from a user's mobile device to determine the distance the user is to the media device. For example, RSSI values may be triangulated to determine a user's location. The media device may also use, for example, triangulation and/or time difference of arrival determination of appropriate information to determine a user's location in relation to a media device. For example, time difference of arrival values of sounds emanating from a user may be determined. In some embodiments, any suitable image processing, video processing, and/or computer vision technique may be used to determine a user's distance, trajectory, and/or location in relation to a media device. A user's distance, trajectory, and/or location in relation to a media device may be determined using any suitable method.

In some embodiments, processing circuitry 306 may determine a location based on global positioning system (GPS) measurements, or in the case of cellular telephones, measurements based on cell-tower signals, done by detecting circuitry 307. Processing circuitry 306 may use these measurements to determine location coordinates which may be transmitted to other media devices.

Memory may be an electronic storage device provided as storage 308 that is part of control circuitry 304. As referred to herein, the phrase “electronic storage device” or “storage device” should be understood to mean any device for storing electronic data, for example, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and media application parameters, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be included with a viewing apparatus located at each seat in a venue. For example, display 312 may be a seat-back display located at each seat in an airplane. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406. For example, the computer equipment for presenting media content in a venue may be implemented as a centralized system or a distributed system. In a movie theatre, there may be a central system with a single display. In a transportation craft, there may be a viewing apparatus located at each seat, such as the seat-back video displays in airplanes.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and one or more web servers 430, coupled to communications network 414 via communication paths 420, 422, 423, and 433 respectively. Paths 420, 422, 423, and 433 may include any of the communication paths described above in connection with paths 408, 410, and 412. Communications with the content source 416, media guidance data source 418, and one or more web servers 430 may be exchanged over one or more communications paths, but are shown as a single path in FIG. 4 to avoid overcomplicating the drawing. In addition, there may be more than one of each of content source 416, media guidance data source 418, but only one of each is shown in FIG. 4 to avoid overcomplicating the drawing. Several instances of web servers 435, 436 and 437 have been illustrated. (The different types of each of these sources are discussed below.) If desired, content source 416 and media guidance data source 418 may be integrated as one source device. Although communications between sources 416 and 418, and web servers 430 with user equipment devices 402, 404, and 406 are shown as through communications network 414, in some embodiments, each of the equipment 416, 418, and 430 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

Web servers 430 may be any number of one or more web servers. For purposes of illustration and simplicity, only three web servers 435, 436 and 437, have been drawn. A web server may host a website, social network, an internet database of information, or any other suitable online service. A web server may be any suitable computer equipment device as described above in reference to FIG. 3. In some embodiments, a web server may act as a media content source, for example, streaming video websites, or as a media guidance data source, for example, a movie review website. In some embodiments, web servers 435-437 may be unrelated. In FIG. 4, the web servers 435-437 have been grouped together as web servers 430 for illustrative purposes.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media applications may be, for example, stand-alone applications implemented on user equipment devices or computer equipment. For example, the media application may be implemented as software or a set of executable instructions which may be stored in storage 308, and executed by control circuitry 304 of a user equipment device 300. In some embodiments, media applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418, or web server 435) running on control circuitry of the remote server. When executed by control circuitry of the remote server (such as media guidance data source 418 or web server 435), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays. Media management applications may be operated similarly to media guidance applications. Media management applications may be operated by administrators that configure how consolidation and matching of media content records is performed. An administrator may locally operate the media management application at a console of a web server or other suitable equipment, or remotely operate the management application through a client application connected to a web server running the management application.

Content and/or media guidance data delivered to user equipment devices 402, 404, 406 or other computer equipment may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. YouTube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications and media management applications (e.g., web-based applications or cloud-based applications), or the content can be displayed by media guidance applications stored on the user equipment device.

Media guidance and management system 400 is intended to illustrate a number of approaches, or network configurations, by which user equipment devices, computer equipment, and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices and computer equipment may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices and computer equipment may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416, one or more media guidance data sources 418 and one or more web servers 430. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having a content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

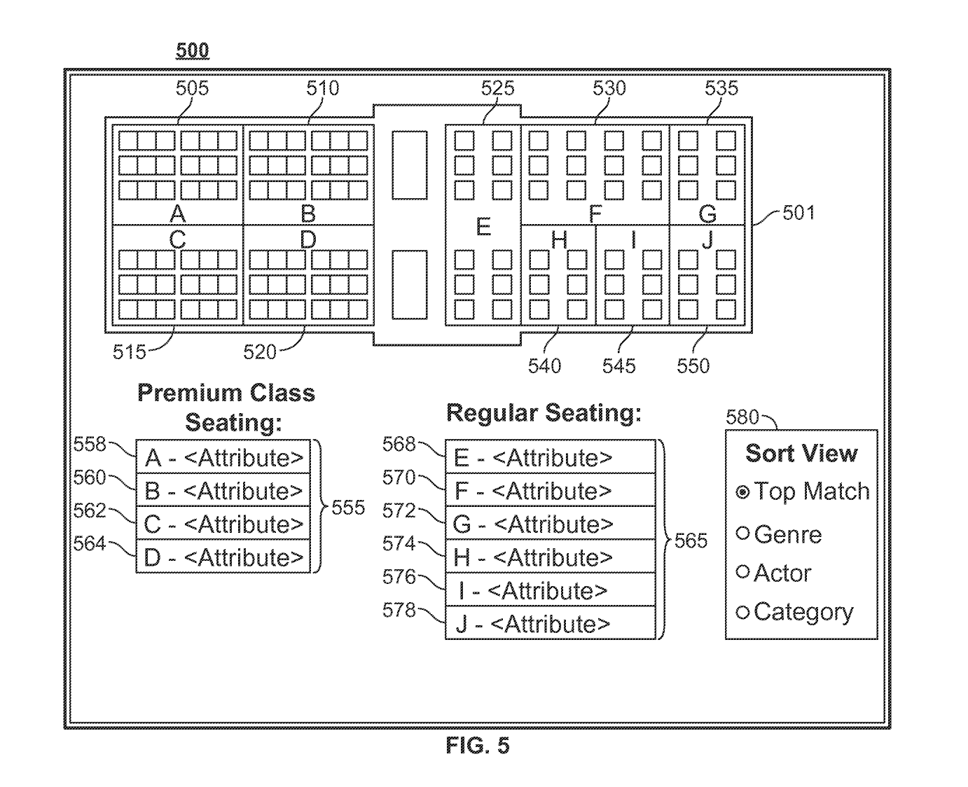

FIG. 5 shows an illustrative interactive media guidance application display screen that includes information about different seating zones and attributes associated with the different seating zones in some embodiments of the present disclosure. Control circuitry of a computer may generate the display 500 in response to receiving a user selection of a menu option such as any option in options region 126 of FIG. 1 or any of options 202 in FIG. 2. The display 500 may be viewed on a display in a venue, such as a central display in a theatre, or a viewing apparatus located at a seat, or may be viewed on any user equipment or personal user device. In some embodiments the display screen may be used by a viewer to reserve a seat prior to attending the venue. For example, control circuitry 304 may generate display screen 500 and receive a user input from a user indicating the selection of a seat. In some embodiments, user seating may be assigned automatically, and displayed to a user. For example, control circuitry 304 may assign a seat to a user based on user profile information corresponding to the user and generate an indicator for display on screen 5000 that shows a user's seating assignment. Display 500 may include a seating display region 501, attributes region 555 and 565, and menu options region 580. It should be understood that there may be other display regions and option regions, but a subset are discussed to avoid overcomplicating the drawings and description. Seating display region 501 may include information about different seating zones located in a venue, such as a theatre or transportation craft. Attributes regions 555 and 565 may include information about the seating zones in display region 501. Menu options region 580 may include a number of selectable options that affects the information displayed in attributes regions 555 and 565.

Seating display region 501 may include a plurality of seating zones 505, 510, 515, 520, 525, 530, 535, 540, 545, and 550. Each of the seating zones may be identified by a label, such an alphabetic letter, number or any other suitable identifier. For example, each of seating zones 505, 510, 515, 520, 525, 530, 535, 540, 545, and 550 may correspond to one of letters A, B, D, E, F, G, H, I or J, respectively. Each seating zone may correspond to a set of user profile attributes, such as favorite movie genre, preferred seating location, or any other suitable user profile attribute. As referred to herein, the term “seating zone” should be understood to mean any number of contiguous or adjacent seats in a venue. A seating zone may include any number of seats in any suitable configuration. Each seat in a venue may be assigned to a seating zone. A venue may include different categories of seats. As referred to herein, the term “seating category” should be understood to mean any classification of seating by cost, location, amenities or any other suitable classifier. For example, in a movie theatre, there may be a number of premium seats that are located in the center of the theatre. For example, in an airplane, there may be first class seats and economy seats. In some embodiments, a seating zone may include seats from one category, or seats from different categories.

Attributes region 555 and 565 may include information about attribute information associated with the seating zones in seating display region 501. Each of attributes regions 555 and 565 may correspond to category of seating. For example, attributes region 555 may correspond to premium seating, and attributes region 565 may correspond to regular seating. Each of the attributes regions may include a plurality of attribute sections, each identified by an identifier. For example, attributes region 555 may include attribute sections 558, 560, 562, and 562, each identified by one of letters A, B, C and D. For example attributes region 565 may include attribute sections 568, 570, 572, 574, 576, and 578, each identified by one of letters E, F, G, H, I and J. Each attribute section may correspond to a seating zone in seating display region 501. Each attribute section may describe an attribute that may be common to users assigned to a corresponding seating zone in display region 501.

Menu options region 580 may include a plurality of selectable menu options, each of which affects the display of attribute information in attributes regions 555 and 565. For example, menu options region may include selectable options of top match, genre, actor, category or any other suitable selectable option. If top match is selected, each attribute section in attributes regions 555 and 565 may display the most common attribute of the users assigned to a corresponding seating zone. For example, the common attribute of seating zone A may be movie genre, while the common attribute of seating zone B may be favorite actor. If genre is selected, each attribute section in the attributes regions may display the value of the most common favorite genre of the users assigned to a corresponding seating zone. If actor is selected, each attribute section in the attributes regions may display the value of the most common favorite actor of the users assigned to a corresponding seating zone. If category is selected, each attribute section in the attributes regions may display the value of the most common category of the users assigned to a corresponding seating zone.

In some embodiments, a viewer's assignment of seating may be restricted to a seating zone that highly correlates with user profile information associated with the viewer. For example, control circuitry 304 may display an indication of a seating zone to which a viewer is restricted by highlighting the seating zone, displaying an outline around the seating zone or using any other suitable indicator. In some implementations, control circuitry 304 may receive a user input indicating a selection of a seating assignment. In some implementations, control circuitry 304 may automatically assign a seat to a user within a correlated zone.

In some embodiments, one or more seating zones may be recommended to a user based on the user profile information associated with the user. For example, control circuitry may generate for display on screen 500 an indication of recommended seating zones by highlighting the recommended seating zone, outline the recommended seating zone or using any other suitable indications.

In some embodiments, a sporting event may be displayed inside the venue. The venue may be a stadium or sports complex in which a live sporting event may be viewed, or in which a broadcast or recording or a sporting event may be viewed. Users may be allocated to zones based on user profile information indicating affiliation with sports teams and enthusiasm with sports. For example, control circuitry 304 may retrieve user profile information for users attending the venue, and determine whether a user's favorite sports team is attending the venue. Control circuitry 304 may select a first cluster of users corresponding to a first sports team participating in the event, and select a second cluster of users corresponding to a second sports team participating in the event. Control circuitry 304 may cluster the remaining users based on other common attribute values. Having separate seating zones corresponding to each sporting participant may make viewing the sporting event more enjoyable as users can cheer on a favorite team together with other like-minded users.

Control circuitry 304 may select any number of clusters of users corresponding to participating sports teams. For example, control circuitry 304 may select at least one cluster per participating team. In some implementations, sub-seating zones may be assigned within larger seating zones to provide additional refinement of seating areas based on interest. For example, control circuitry 304 may select a sub-cluster, based on favorite player information in user profiles, from the first cluster of seats corresponding to a sporting team.

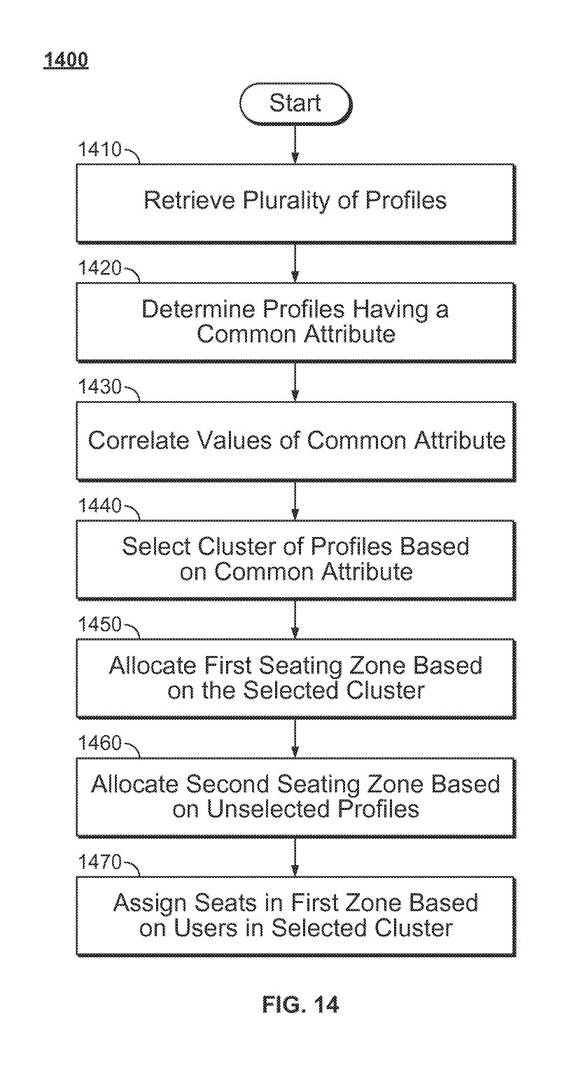

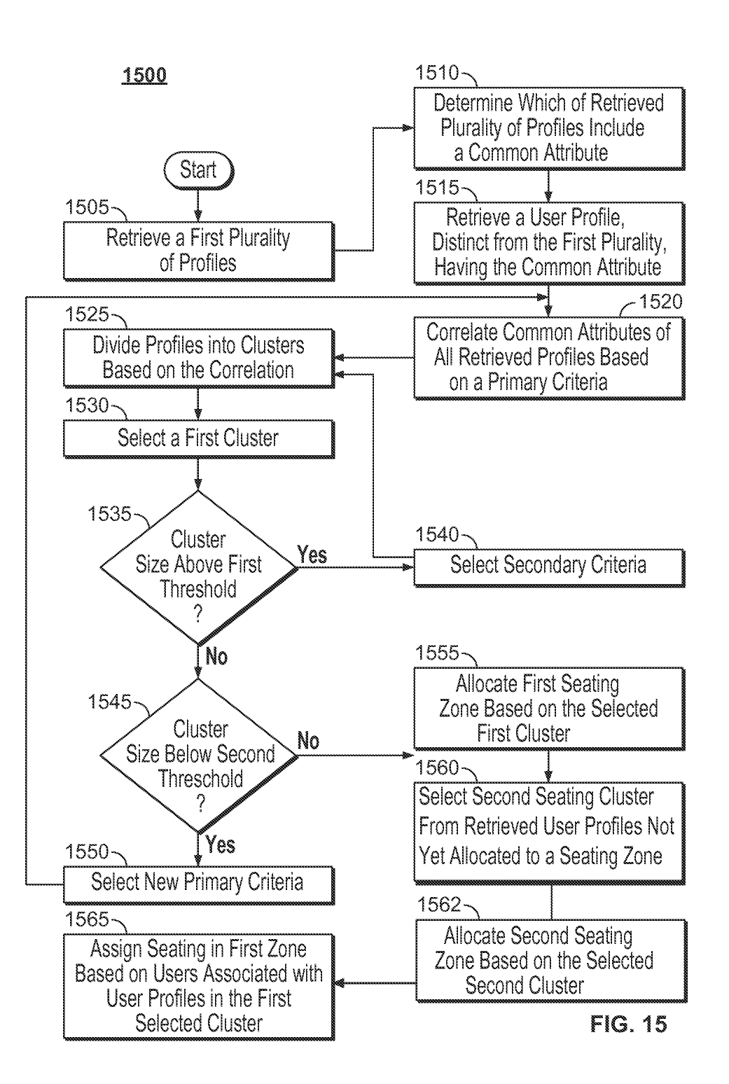

In some embodiments, control circuitry 304 may generate display screen 500 after a certain number of users have purchased a ticket to attend a venue. A minimum number of user profiles may be desired in order to select sizeable clusters for allocation of seating zones within the venue. For example, control circuitry 304 may determine whether a number of users that purchased a ticket to attend the venue has exceeded a certain threshold. In response, control circuitry 304 may retrieve user profiles corresponding to each user that has purchased a ticket, correlate common attribute values of the user profiles, and select clusters of users based on the correlation of the common attribute values. The correlation process is discussed in further detail below in reference to FIG. 14 and FIG. 15. Control circuitry 304 may allocate seating zones within the venue to one or more selected clusters, and generate the display 500 based on the selected clusters and allocated seating zones.

In some embodiments, control circuitry 304 may iteratively update the display of screen 500 as additional users purchase tickets to attend the venue. For example, control circuitry 304 may determine that a distinct user has purchased a ticket to attend the venue, and retrieve one or more distinct user profiles associated with the user. Control circuitry 304 may then correlate common attribute values of the distinct user profiles with other retrieved user profiles associated with users that have already purchased a ticket to attend the venue. Control circuitry 304 may add the distinct user to an existing cluster, and reallocate a corresponding seating zone to include an additional seat for the distinct user. Control circuitry 304 may then generate or update for display to the distinct user screen 500 that indicates available seats that may be assigned to the distinct user automatically, or in response to a selection of a seat from the distinct user.

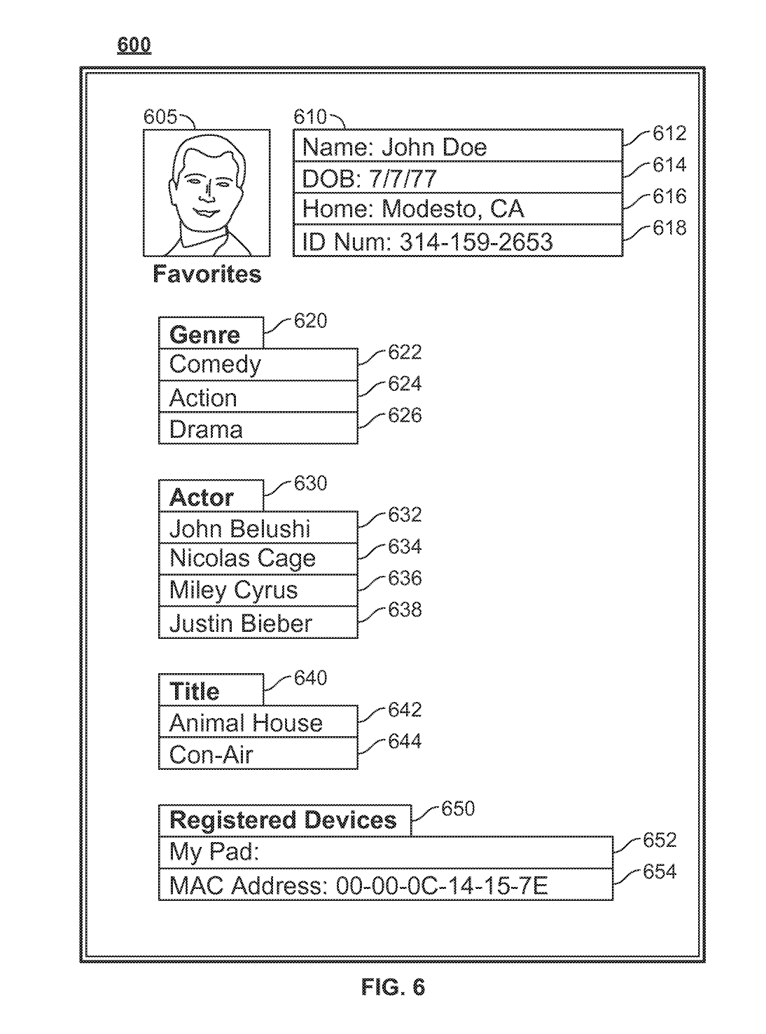

FIG. 6 shows an illustrative interactive media guidance application display screen that includes user profile information such as personal information and user viewing habits in some embodiments of the present disclosure. For example, the user profile may be a media guidance application user profile. Control circuitry of an electronic device may generate the display 600 in response to receiving a user selection of a menu option such as any option in options region 126 of FIG. 1 or any of options 202 in FIG. 2. Display 600 may include a user profile image 605, personal information region 610, one or more media guidance data regions 620, 630 and 640, and electronic device region 650. It should be understood that there may be other display regions and option regions, but a subset are discussed to avoid overcomplicating the drawings and description. User profile image 605 may be a photograph, icon, or any other suitable graphic identifier of a user. The user profile information shown in screen 600 may be stored and retrieved from any of web servers 430, or from a personal user device 406 associated with a user.

Personal information region 610 may include one or more personal information fields 612, 614, 616 or 618. Each personal information field may contain an attribute of a user's personal information. For example, field 612 may include a name and field 614 may include a birthdate. Field 616 may include a hometown, state, any other geographic location information or any combination thereof. Field 618 may include an identification number or any other suitable unique identifier of the user profile. The personal information region may also include identification numbers of other user profiles associated with the user corresponding to the profile of display 600.

Each of guidance data regions 620, 630 and 640 may include information about a user's media content attributes. Each guidance data region may have one or more content attribute fields that include instances or values of an attribute. For example, guidance data region 620 may describe a user's favorite genre and have attribute fields 622, 624 and 626 which include values comedy, action, and drama, respectively. For example, guidance data region 630 may describe a user's favorite actors and have attribute fields 632, 634, 636 and 638 which each include the name of an actor. For example, guidance data region 640 may describe titles of a user's favorite movies and have attribute fields 642 and 644 which each include the title of a movie. The attribute fields in guidance data region may be ordered according to an alphabetical order, user ranking, or any other suitable order.

Electronic device region 650 may include and describe information about one or more electronic devices that may be used by a user to view media content. The user profile information may be generated by information collected from one or more of the electronic devices. Each electronic device may be described by one more electronic device fields 652 and 654. For example in FIG. 6, a single device is illustrated, and is described by a device name in field 652 and a unique identifier in field 654. In some embodiments, the electronic devices displayed in region 650 may be detected by detecting circuitry 307.

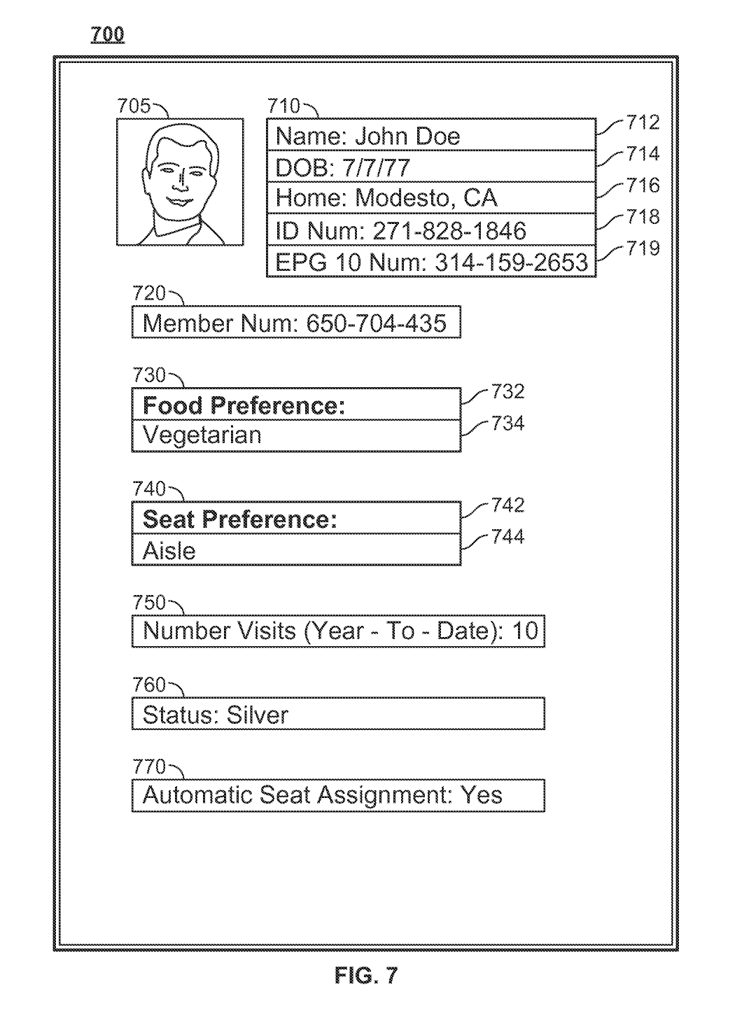

FIG. 7 shows an illustrative display screen that includes user profile information associated with a venue or service in some embodiments of the present disclosure. Control circuitry of an electronic device may generate the display 700 in response to receiving a user selection of a menu option such as any option in options region 126 of FIG. 1 or any of options 202 in FIG. 2. Display 700 may include a user profile image 705, personal information region 710, one or more service data regions 720, 730, 740, 750, 760, and 770. It should be understood that there may be other display regions and option regions, but a subset are discussed to avoid overcomplicating the drawings and description. User profile image 705 may be a photograph, icon, or any other suitable graphic identifier of a user. The user profile information shown in screen 700 may be stored and retrieved from any of web servers 430, or from a personal user device 406 associated with a user.

In some embodiments, the allocation of seating zones and assignment of seating in venues may be enhanced by combining information from multiple user profiles. For example, a first user profile described in FIG. 6 provides information about a user's media content viewing preferences. A second user profile described in FIG. 7 provides information about a user's preferences when using the services of a venue. Control circuitry 304 may incorporate both sets of information to select clusters of related users and corresponding user profiles for allocation to seating zones. For example, control circuitry 304 may select a cluster of users and corresponding user profiles that share a common interest in comedy movies as described in media guidance profile information shown in FIG. 6, and have a preference for sitting near aisles, as indicated in service profile information shown in FIG. 7. For example, control circuitry 304 may select clusters of users and associated user profiles, and allocate zones of premium seating, such as zone 558 in FIG. 5, based on membership status, shown in FIG. 7, and based on favorite genre, described in FIG. 6.

Personal information region 710 may include one or more personal information fields 712, 714, 716, 718 or 719. Each personal information field may contain an attribute of a user's personal information. For example, field 712 may include a name and field 614 may include a birthdate. Field 716 may include a hometown, state, any other geographic location information or any combination thereof. Field 718 may include an identification number or any other suitable unique identifier of the user profile. Field 719 may include a unique identifier of another user profile associated with the user. For example, field 719 may include a unique identifier of a media guidance application user profile, as described above in reference to FIG. 6.

Each of service data regions 720, 730, 740, 750, 760 and 770 may include user specific information about the service associated with the service profile. Each service data region may have one or more service attribute fields that include instances or values of an attribute. A first service attribute field may describe the service attribute, and a second service attribute field may provide a value for the service attribute. For example, service data region 720 may include a membership number of a user. For example, service data region 730 may describe a user's food preferences based on foods consumed at the venue or through a service. Service attribute field 732 may indicate a food preference attribute, and service attribute field 734 may indicate food preference value of vegetarian food. For example, service data region 740 may describe a user's seat preference in the venue. Service attribute field 742 may indicate a seat preference attribute, and service attribute field 744 may indicate a seat preference value of aisle seats. The service attribute field. In some embodiments, the service attributes may be shown as a single row in a service data region. For example, service data region 750 may indicate a frequency attribute, which shows that a user has visited a venue 10 times in the current year. For example, service data region 760 may indicate a status attribute, which shows that a user has a certain status level in membership rewards program with the service. For example, service data region 770 may indicate a seating assignment attribute which shows that a user prefers automatic seating assignment instead of manually selected seating assignment.

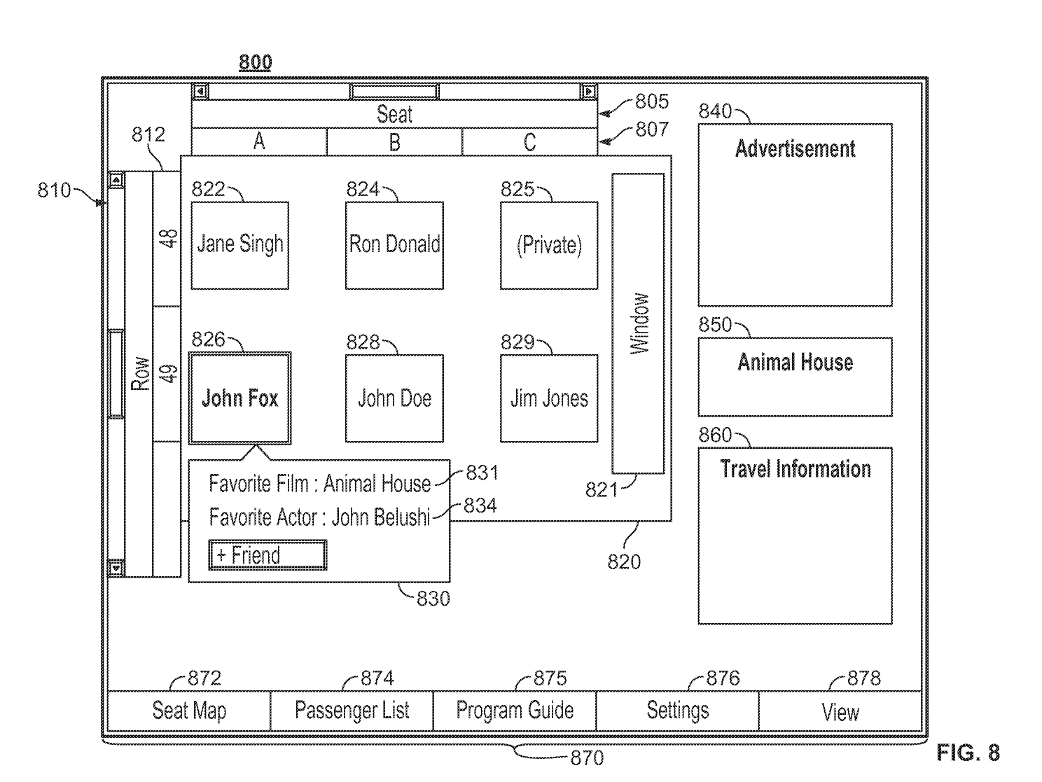

FIG. 8 shows an illustrative display screen that includes detailed information about a seating zone and users assigned to the seating zone in some embodiments of the present disclosure. Control circuitry of an electronic device may generate the display 800 in response to receiving a user selection of a menu option such as any option in options region 126 of FIG. 1 or any of options 202 in FIG. 2. Display 800 may include a seating zone display region 820, advertisement region 840, media content information region 850, service information region 860, and menu options region 870. It should be understood that there may be other display regions and option regions, but a subset are discussed to avoid overcomplicating the drawings and description.

Seating zone display region 820 illustrates seating assignments for a plurality of users. Because the physical display size may be limited, only a portion of the entire seating zone may be shown in display region 820. To change the displayed portion of a seating zone, navigation bars 805 and 810 may be included. Coordinate bars 807 and 812 may be included to identify coordinates of a seat within the displayed seating zone. For example, navigation bar 810 may be a vertical scroll bar and navigation bar 805 may be a horizontal scroll bar. The displayed portion of a seat map may be changed in response to receiving a user selection of any of the navigation bars.

Seating zone display region 820 may include one or more graphical identifiers (822, 824, 825, 826, 828 and 829) of a seat within a seating zone. A descriptor identifying a user assigned to a seat may be shown with the graphical identifier. For example, the descriptor may be a name, or any other personal information included in personal information regions 610 and 720 in FIGS. 6 and 7. Seating zone display region 820 may include a reference marker 821 that corresponds to physical reference points to locate a displayed seating zone within a venue. For example, if the venue is an airplane, the reference marker may indicate an aisle or window.

Each graphical identifier of a seat in display region 820 may be selectable. A selected identifier may be indicated by a marker, such as identifier 826 in FIG. 8. Control circuitry of an electronic device may generate for display an overlay region 830 which includes information about a user assigned to the selected seat, and menu options for interacting with the user. For example, overlay region 830 may include information regions 831 and 834, which display information from the user's media guidance application profile, such as favorite film and favorite actor. Overlay region 830 may also include one or more selectable menu options that enable interactivity with the user assigned to the selected seat. For example, a menu option may enable sending a request to add the selected user to a social network.

In some embodiments, a user may set privacy settings in a user profile assigned with the venue. For example, graphical identifier 825 is associated with a user who has set privacy to prevent display of the user's name in seating zone display region 820, and does not show the user's name.

Advertisement region 840 may include a display of a selectable advertisement. The advertisement may be text, picture, video, or any other suitable media content. Media content information region 850 may include information about a media content asset. In some embodiments, media content region 850 may include information associated with media content information shown in overlay display region 850. For example, in response to a selection of one of information regions 831 or 834, detailed information may be displayed in media content region 850.

Service information region 860 may show information associated with a service or venue. In some embodiments, the venue may be a transportation craft in transit. Service information region 860 may display travel information, such as estimated time to arrival, elapsed time since departure or any other suitable travel information.

Menu options region 870 may include one or more selectable menu options 872, 874, 875, 876, 878. Each menu option may correspond to a display screen. In response to receiving a user selection of a menu option, control circuitry of an electronic device may generate for display the associated menu screen. Screens 800, 900, 1000, 1100 and 1200 may be displayed in response to receiving a user input one of menu options 872, 874, 875, 876 and 878 respectively.

In some embodiments, screen 800 of FIG. 8 may generate for display in response to a user selection of any of the seating zones 558, 560, 562, 568, 570, 572, 574, 576, or 578 shown in FIG. 5. Control circuitry 304 may generate screen 800 of FIG. 8 for display to a user during selection of seats prior to attending a venue. The display may include a highlight region indicating a recommended seating zone to a user, or restricted seating zone for a user. Control circuitry 304 may receive a user selection of a seat, and assign a selected seat to a user. In some implementations, control circuitry 304 may enable a user to change seating assignments in response to receiving a selection of a seat from a user.

In some embodiments, screen 800 may be generated to illustrate automatic seating assignments. Control circuitry may iteratively assign seating within a seating zone. The process discussed in further detail below in reference to step 1565 of FIG. 15.

Control circuitry 304 may generate screen 800 of FIG. 8 for display to a user when a user attends a venue. For example, control circuitry 304 may generate the screen 800 for display on a viewing apparatus at the venue. The screen may enable to a user to view information about users assigned to a seating zone.

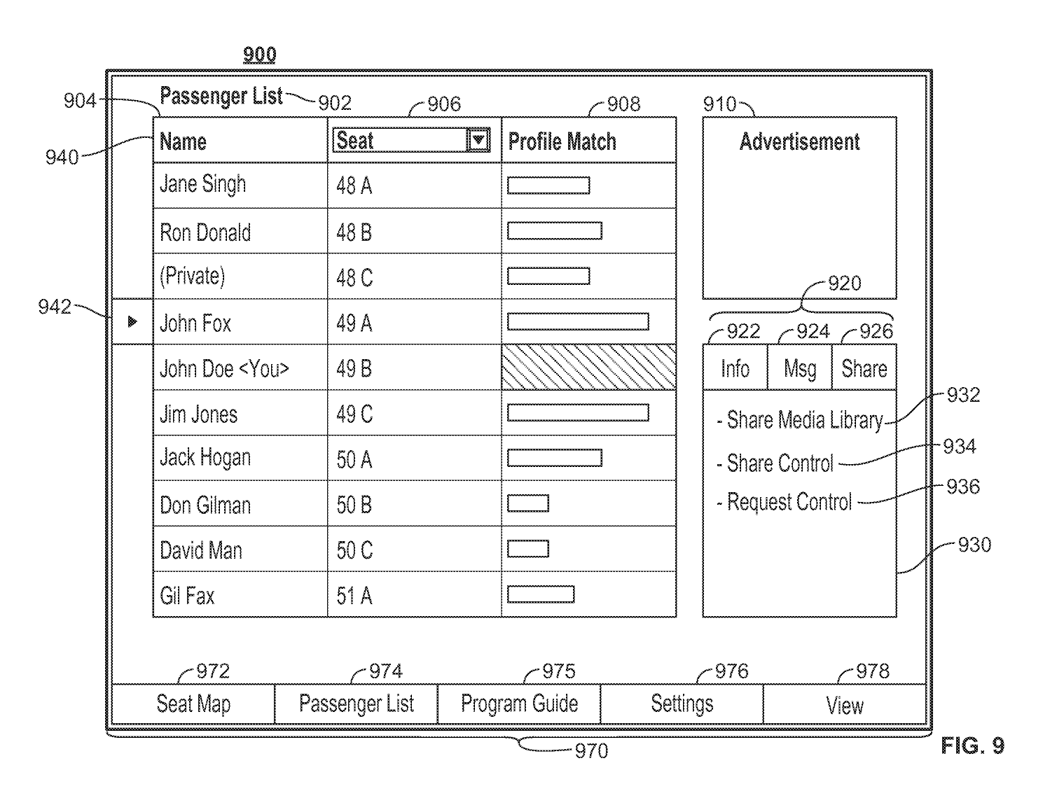

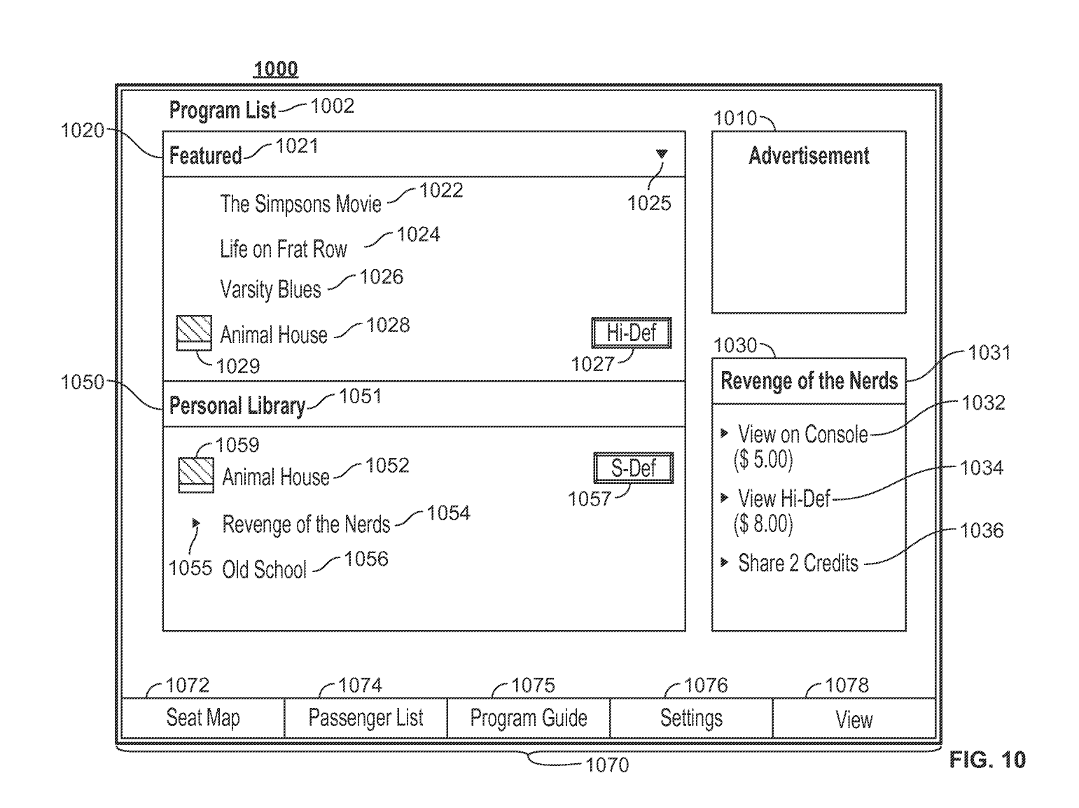

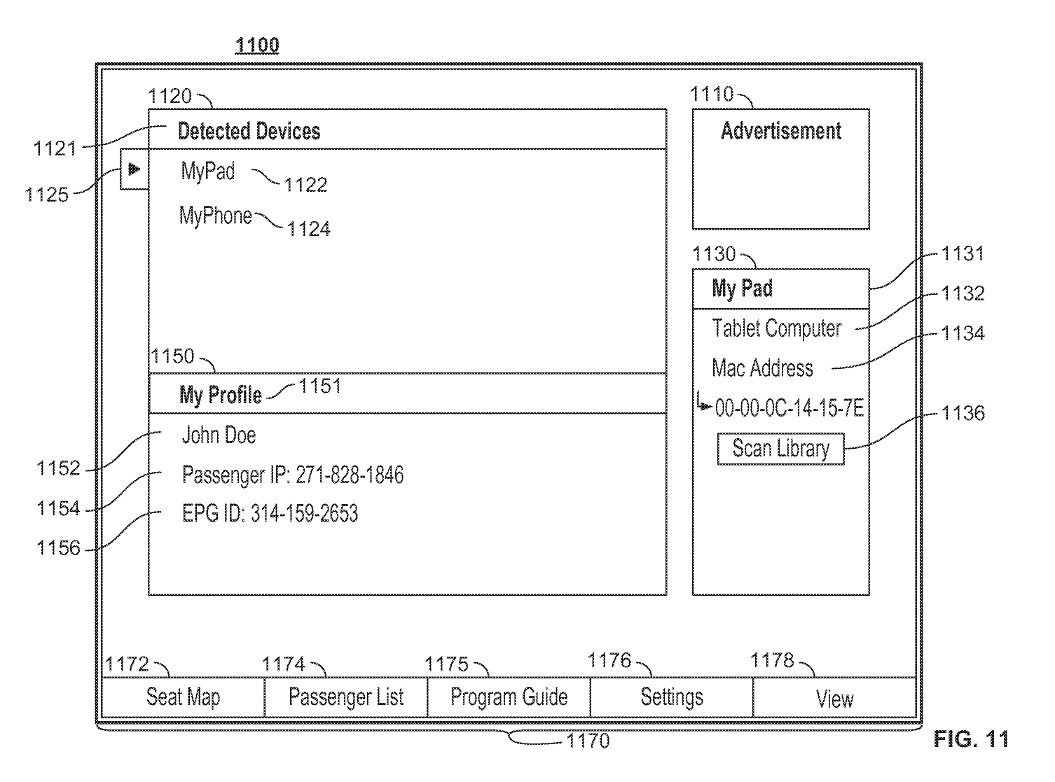

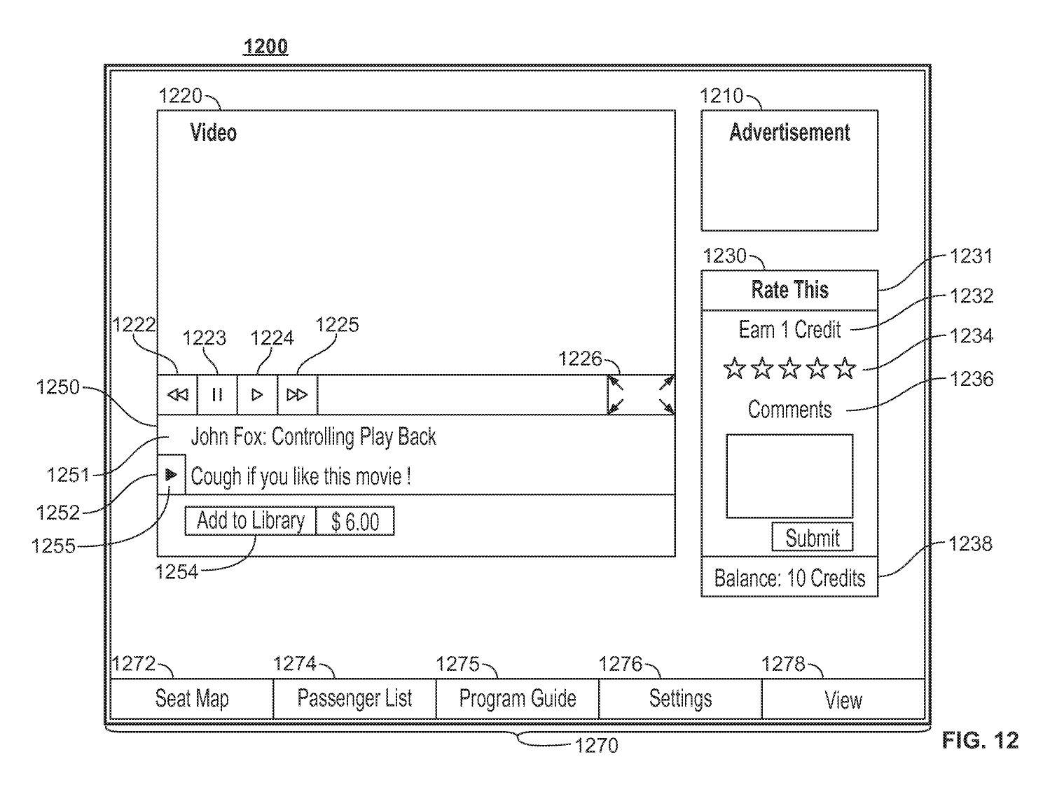

FIG. 9 shows an illustrative display screen that includes detailed information about users assigned to a seating zone in some embodiments of the present disclosure. Control circuitry of an electronic device may generate display screen 900 in response to receiving a user selection of any menu option in options region 126 of FIG. 1, any of options 202 in FIG. 2, or option 874 in FIG. 8, option 974 in FIG. 9, option 1074 in FIG. 10, option 1174 in FIG. 11 or option 1274 in FIG. 12.

Display screen 900 includes a seat information list 902 of seated users 902, advertisement region 910, control menu 930, and a menu options region 970. It should be understood that there may be other display regions and option regions, but a subset are discussed to avoid overcomplicating the drawings and description. Seat information list 902 may include one or more columns 904, 906 and 908 that include information about seated users. Header row 940 describes information about information contained in the one or more columns. Each row in the list may correspond to a seated user. Column 904 may include identifiers of a user, such as name. Column 906 may include seat assignments of a user. In some embodiments, the seat assignments may be described by coordinates corresponding to coordinate bars 807 and 812, as discussed above in reference to FIG. 8. In some embodiments, the information displayed in column 906 may be selected by a pull down menu. Column 908 may include information about a level of a profile match between a selected user in the list 902, and a user viewing display screen 970. For example, the level of profile match may be represented by a horizontal bar, in which longer bars indicate a higher level of profile match. Control circuitry 304 may correlate common attribute values of one or more profiles within a seating zone and compute a correlation score per common attribute for each user corresponding to a user profile allocated to a seating zone illustrated in FIG. 9. The level of profile match in column 908 may be based on one more of the correlation scores. For example, control circuitry 304 may compute a weighted average of one or more correlation scores and generate for display a level of profile match illustrated in column 908. Each correlation score may be evaluated relative to an average and variance of scores computed across user profiles in a selected cluster of correlated user profiles. For example, control circuitry 304 may normalize the correlation scores by computing a Z-score based on a variance and average of correlation scores, scaling a score by the average or variance, or subtracting the average score. List 902 may include a selector indicator 942 to indicate a user selection of one of the rows in the list.

Advertisement region 910 may be substantively similar to advertisement region 810 discussed above in reference to FIG. 8. Menu options regions 970 may be substantively similar to menu options region 870 discussed above in reference to FIG. 8.

Control menu 930 may include a menu bar 920 that includes one or more command type options 922, 924 and 926. A selected menu command type option may be indicated by shading or any other suitable indicator. Menu command type options may be used to select a type of media guidance application command. For example, menu command type option 922 may include command options to access information about media content assets. Message command type option 924 may include command options to communicate messages with one or more users displayed in the seat information list 902. Share command type options 926 may include command options to share media content with one or more users displayed in seat information list 902. For example, the display of the share command type may include one or more command options 932, 934, or 936, which enable sharing of a media library, sharing control of media content playback, and requesting control media control of media content playback.

Control circuitry 304 may generate the control menu for display to enable user interaction with other users in the same allocated seating zone. Control circuitry 304 may receive a user selection of one of commands 932, 934, 936 and execute the corresponding function described above. For example, control circuitry 304 may receive a user selection of a “share media library” command 932, and send a request to a viewing apparatus associated with selected user John Fox indicated by indicator 942. In response, control circuitry of a viewing apparatus associated with the user John Fox may generate for display an indication of a request to share a media library. In response to receiving a user confirmation, control circuitry of the viewing apparatus associated with the selected user may enable the sharing of the media library. The media libraries are discussed in further detail below in reference to FIG. 10.

FIG. 10 shows an illustrative display screen that includes information about media content that may be viewed in a venue in some embodiments of the present disclosure. Control circuitry of an electronic device may generate display screen 1000 in response to receiving a user selection of any menu option in options region 126 of FIG. 1, any of options 202 in FIG. 2, or option 875 in FIG. 8, option 975 in FIG. 9, option 1075 in FIG. 10, option 1175 in FIG. 11 or option 1275 in FIG. 12. In some embodiments, a user may use display screen 1100 to rent the viewing equipment to display media content that is accessible to the user. For example, a user may wish to view media content stored on a personal user device on a viewing apparatus because the viewing apparatus has a higher resolution screen. For example, a user may wish to access streaming content from an online subscription service. In some embodiments, a user may share media content with other users for viewing on the viewing apparatus. Methods for sharing media content are described in U.S. patent application Ser. No. 13/341,546, which is hereby incorporated herein by reference in its entirety.

Display screen 1000 includes a program list 1002, advertisement 1010, control menu 1030, and menu options region 1070. It should be understood that there may be other display regions and option regions, but a subset are discussed to avoid overcomplicating the drawings and description. Program list 1002 may include a featured display region 1020, and a personal library display region 1050. Featured display region 1050 may include one or more selectable listings 1022, 1024, 1026, and 1028 of media content assets that may be accessed for viewing. Playback indicator 1029 may indicate that a media content asset associated with a listing is currently being played back. Quality indicator 1027 may indicate the quality of the media content asset associated with a listing.

Control circuitry 304 may generate for display the listings in featured display region 1020 based on media assets that are accessible at the venue. For example, control circuitry may access a set of listings from a media content source 416 or a media guidance data source 418 at a venue and display a list of media assets that are accessible to viewers attending the venue.

Personal library display region 1050 may include one or more selectable program listings 1052, 1054, or 1056 of media content assets that are owned by a user. Playback indicator 1059 indicates that a media content asset associated with the listing is currently being played back. Quality indicator 1057 indicates the quality of a media content asset associated with a listing. Marker 1055 may indicate a currently selected media content listing. Control circuitry 304 may generate for display the listings in personal library region 1050 based on media assets that are accessible to a user. Control circuitry 304 may retrieve a listing of assets that are available to a user from a personal user device 406 that is coupled to a viewing apparatus, or from a media content source 416, media guidance data source 418, or any of web servers 430. The listings information may be retrieved based on account information such as personal information field 618, 718 or 719, illustrated in FIGS. 6 and 7.

Advertisement region 1010 may be substantively similar to advertisement region 810 discussed above in reference to FIG. 8. Menu options regions 1070 may be substantively similar to menu options region 870 discussed above in reference to FIG. 8.

Control menu 1030 may include a title of a media content asset 1031, and one or more command options 1032, 1034, and 1036 for accessing a selected media content asset indicated by marker 1055. For example, command option 1032 may enable viewing the content on an electronic device in a venue. Command option 1034 may enable selection of the quality of media content asset for playback. Command option 1036 may enable sharing of the media content asset associated with the selected listing.

FIG. 11 shows an illustrative display screen that includes information about a user and a user device in a viewing venue in some embodiments of the present disclosure. Control circuitry of an electronic device may generate display screen 1100 in response to receiving a user selection of any menu option in options region 126 of FIG. 1, any of options 202 in FIG. 2, or option 876 in FIG. 8, option 976 in FIG. 9, option 1076 in FIG. 10, option 1176 in FIG. 11 or option 1276 in FIG. 12.

Display screen 1100 includes detected device region 1120, user profile region 1150, advertisement 1110, control region 1130, and menu options region 1170. It should be understood that there may be other display regions and option regions, but a subset are discussed to avoid overcomplicating the drawings and description. Detected device region 1121 may include one or more listings of user devices that are detected near the electronic device that is displaying screen 1100. Control Circuitry 304 may detect the devices using detecting circuitry 307. For example, device listing 1122 indicates a first detected user device named MyPad, and device listing 1124 indicates a second detected user device named MyPhone. Each detected user device may contain user profile information of an associated user, or may contain information about media content assets that may be played back, such as information about subscriptions to content providers, or files of media content assets. Indicator 1125 indicates a selection of a device listing.

User profile region 1150 includes user profile information about a user associated with the selected device indicated by indicator 1125. User profile region may contain one or more information elements 1152, 1154, or 1156 that contain information from personal information regions 610 and 710 as discussed above in reference to FIG. 6 and FIG. 7 respectively.

Advertisement region 1110 may be substantively similar to advertisement region 810 discussed above in reference to FIG. 8. Menu options regions 1170 may be substantively similar to menu options region 870 discussed above in reference to FIG. 8.

Control menu 1130 includes detailed device information corresponding to the selected device listing 1122. Control menu 1130 may include one or more information elements 1131, 1132, and 1134 that describe the selected device. For example element 1130 describes the name of the selected device, element 1132 describes the type of selected device, and element 1134 describes a selected address of the selected device. Control menu 1130 may also include one or more command options for performing commands on the device. For example, command option 1136 enables scanning the media library of the device to determine listings of media content assets that are accessible by the device. The media content assets may be played back using a viewing apparatus, or may be shared with other users for playback. For example, control circuitry 304 of a computer may receive a user input indicating selection of command option 932 in screen 900 to share a media library that may include information about media content assets stored in a detected device.

FIG. 12 shows an illustrative display screen that shows media content that may be viewed in some embodiments of the present disclosure. Control circuitry of an electronic device may generate display screen 1200 in response to receiving a user selection of any menu option in options region 126 of FIG. 1, any of options 202 in FIG. 2, or option 878 in FIG. 8, option 978 in FIG. 9, option 1078 in FIG. 10, option 1178 in FIG. 11 or option 1278 in FIG. 12.

Display screen 1200 includes a media display region 1220, advertisement region 1210, media content information region 1250, and interactive region 1230. It should be understood that there may be other display regions and option regions, but a subset are discussed to avoid overcomplicating the drawings and description. Control circuitry of an electronic device plays back a selected media content asset in media display region 1220. Media content display region may include selectable command buttons 1222, 1223, 1224 and 1225 to control trick play function for a media content asset, such as rewind, pause, play, and fast forward respectively. Command button 1226 may be used to enlarge the media display region 1220 to occupy the full screen of the device.

Media information region 1250 may include information about the playback of the media content asset displayed in region 1220, in one or more information elements. For example, information element 1251 may indicate which user is controlling playback of video. In some embodiments, a first user may control playback of video for one or more selected users seated within the same seating zone. Playback of a media content asset at the viewing apparatus of each of the one or more selected users may be synchronized with the playback of the media content asset at the viewing apparatus associated with the first user. The first user may request control for playback from other users. For example, control circuitry 304 of a computer may receive a user input indicating selection of command 936 in screen 900 from the first user, to request control from a selected user indicated in seat information list 902.

The selected user may request to share control of playback with the first user. For example, control circuitry 304 of a computer may receive a user input indicating selection of command 934 in screen 900 to share control of playback with the first user, indicated in a seat information list 902. A first user may also request to share control of playback with one or more selected users. For example, control circuitry 304 of a computer may receive a user input indicating selection of command 934 in screen 900 to share control of playback with one or more selected users indicated in a seat information list 902. In this way, sub-groups within a seating zone may be formed to view and synchronize playback of a media content asset. Each of the users within the sub-group may jointly control playback of the media content asset. For example, control circuitry 304 of a computer may receive a user input indicating selection of command button 1224 from a first user associated with a first viewing apparatus and in response, playback a media content asset. Control circuitry 304 of a computer may receive a user input indicating selection of command button 1223 from a second user associated with a second viewing apparatus and in response, pause playback of the media content asset.

In some embodiments, a user may individually control playback of a viewing apparatus by directly operating the viewing apparatus. For example, control circuitry 304 of a computer may receive a user input indicating selection of one of command buttons 1222, 1223, 1224 and 1225, and in response control playback of the media content asset according to the selected command.

Information element 1252 may indicate a message received from one or more users concurrently viewing the media content asset. Information region 1250 may include one or more selectable commands. For example, selectable command 1254 may enable a user to purchase an access right to the media content that is played back in region 1220.

Interactive region 1230 enables a user to provide feedback about the media content asset displayed in region 1220, and interact with other users who are concurrently viewing the media content asset. For example, interactive region 1230 may enable a user to rate content or provide comments in order to earn virtual currency. For example, information element 1231 and 1232 provide information on the type of activity and reward. For example, input region 1234 enables a user to input a quantitative rating of the media content by selecting a number of rating indicators. Input region 1236 enables a user to input text comments about a program. Information element 1238 may display a balance of virtual currency.

Advertisement region 1210 may be substantively similar to advertisement region 810 discussed above in reference to FIG. 8. Menu options regions 1270 may be substantively similar to menu options region 870 discussed above in reference to FIG. 8.

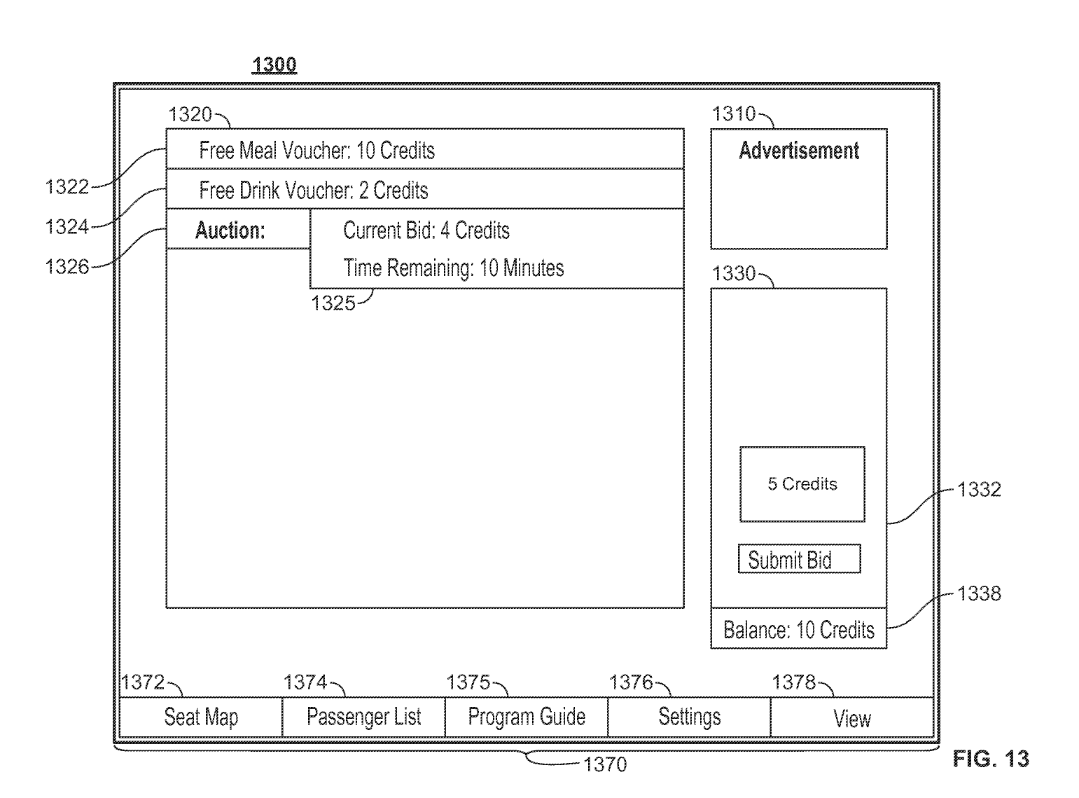

FIG. 13 shows an illustrative display screen that shows interactive user activities that may take place in the viewing venue in accordance with some embodiments of the present disclosure. In some embodiments, users of a venue may participate in interactive activities such as auctions and trivia competitions, interactive games, or any other suitable interactive activities. Display screen 1300 is an illustrative screen that may enable such activities. Control circuitry of an electronic device may generate display screen 1200 in response to receiving a user selection of any menu option in options region 126 of FIG. 1, any of options 202 in FIG. 2, or any other suitable menu option. Display screen 1300 enables a user to view a balance of virtual currency earned from participating in interactive activities and exchange the virtual currency. Display screen 1330 may include an exchange activity screen 1320, advertisement 1310, interactive region 1330, and menu options region 1370. It should be understood that there may be other display regions and option regions, but a subset are discussed to avoid overcomplicating the drawings and description. In some embodiments, display screen 1300 may be generated for each viewing apparatus by control circuitry at a server computer. In some embodiments, display screen 1300 may be generated for each viewing apparatus by control circuitry located at each viewing apparatus, or associated with each viewing apparatus.

Advertisement region 1310 may be substantively similar to advertisement region 810 discussed above in reference to FIG. 8. Menu options regions 1370 may be substantively similar to menu options region 870 discussed above in reference to FIG. 8.

Exchange activity screen 1320 may include a first prize listing 1322, a second prize listing 1324, and auction information region 1325. The prize listings may include information about the type of auction prizes. The auction prizes may correspond to items that may be consumed within the venue, such as food or meal vouchers, or may correspond to items that can be delivered to a winner of the auction. Auction information region 1325 may include information such as the current bid highest bid from a user, and the time remaining in the auction.

Interactivity region 1330 may include form region 1332 and balance display region 1338. Form region 1332 may be used to enter values of the bid. For example, control circuitry 304 of a computer equipment or viewing apparatus may receive an input from a user to submit a bid for the auction. Balance display region 1338 may include information about a balance for a user account from which bid amounts may be withdrawn.

FIG. 14 illustrates a flowchart of steps for a process 1400 that may be implemented by a system for allocating seating zones and assigning seats within seating zones in some embodiments of the present disclosure. Process 1400 may be initiated after a number of users reserving access to a venue has exceeded a certain number. For example, control circuitry 304 may determine that a number of users reserving access to a venue has exceeded a threshold, and commence correlation of user profiles to allocate seating zones. Process 1400 may be initiated after a distinct user reserves access to a venue, in order to update the allocation of seating zones. At step 1410, a plurality of user profiles is retrieved. For example, control circuitry 304 of a computer equipment may retrieve a plurality of user profiles from a storage of any one of web servers 430 or a wireless communications device 430. Control circuitry 304 may retrieve the plurality of user profiles in response to receiving a request to display screen 500 of FIG. 5, or display screen 800 of FIG. 8.

At step 1420, it is determined which of the retrieved plurality of user profiles have a common attribute. For example, control circuitry 304 of the computer equipment may determine which of the retrieved plurality of profiles have a common attribute by comparing the attributes of the retrieved plurality of user profiles. For example, control circuitry 304 may compare attributes corresponding to media guidance data regions 620, 630 or 640 in FIG. 6 of several user profiles, or may compare the attributes corresponding to service data regions 730 or 740 in FIG. 7 to determine common attributes.

At step 1430, values of the common attribute of the plurality of user profiles may be correlated. For example, control circuitry 304 of the computer equipment may correlate the values of the common attribute of the plurality of user profiles. The control circuitry may extract common attributes and corresponding values of the common attributes from the plurality of user profiles and correlate the values. For example, control circuitry 304 may extract the genre attribute corresponding to region 620 in FIG. 6, from a plurality of user profiles and correlate values from attribute fields such as 622, 624 or 626 in FIG. 6. For example, control circuitry 304 may extract a seat preference attribute corresponding to region 740 in FIG. 7, from a plurality of user profiles and correlate values from attribute fields such as 744 in FIG. 7.

At step 1440, a cluster of user profiles is selected based on the correlation of the common attribute values. For example, control circuitry 304 of a computer equipment may select a cluster of user profiles based on the correlation of the common attribute values of the user profiles. Control circuitry 304 may compute a correlation score for each user profile, and compare the computed score to a threshold. The control circuitry may select the user profiles corresponding to correlation scores that exceed the threshold. For example, control circuitry 304 my correlate the values from attribute fields 622, 624, or 626 for a genre attribute, shown in FIG. 6, and select a correlated group of users with corresponding user profiles.

At step 1450, a first seating zone is allocated based on the selected cluster of user profiles. For example, control circuitry 304 of a computer equipment may allocate a first number of a plurality of seats in a proximate relationship to a first seating zone, where the first number corresponds to the size of the selected cluster of user profiles. The control circuitry may allocate the seating zone in any shape, size or configuration. The zone may include contiguous seats, or noncontingous groups of seats. For example, control circuitry 304 may allocate a seating zone 505 shown in FIG. 5 based on a selected cluster of users with user profiles having correlated genre attribute values. Although one seating is discussed as an example, any of the seating zones may be allocated in this way.

At step 1460, a second seating zone may be allocated based on the unselected user profiles. For example, control circuitry 304 of a computer equipment may determine common attributes of a set of the unselected profiles and correlate values of the common attributes. Based on the correlation, a second seating zone may be allocated by the control circuitry for a set of the unselected profiles. For example, control circuitry 304 may allocate a seating zone 510 shown in FIG. 5 based on a selected cluster of users with user profiles having correlated actor attribute values. Although one seating is discussed as an example, any of the seating zones may be allocated in this way.

At step 1470, seats in the first seating zone may be assigned to users associated with user profiles in the selected cluster of user profiles. For example, control circuitry 304 of a computer equipment may assign seats to a user associated with user profiles in the selected cluster of user profiles. Control circuitry 304 may assign the seats in the seating zone using any suitable assignment algorithm. In some implementations, the seats may be assigned automatically by control circuitry. In some implementations, the seats may be assigned in response to receiving an input from a user. For example, control circuitry 304 may receive a user input when screen 500 of FIG. 5 or when screen 800 of FIG. 8 is displayed, requesting assignment to a specific seat. In response, control circuitry may assign the requested seat.

FIG. 15 illustrates a flowchart of steps for a process 1500 that may be implemented by a system for allocating seating zones and assigning seats within seating zones according to user profile information in some embodiments of the present disclosure. The process 1500 is a more detailed version of process 1400 illustrated in FIG. 14. Process 1500 may be initiated after a number of users reserving access to a venue has exceeded a certain number. For example, control circuitry 304 may determine that a number of users reserving access to a venue has exceeded a fixed threshold, and commence correlation of user profiles to allocate seating zones. Process 1500 may be initiated after a distinct user reserves access to a venue, in order to update the allocation of seating zones. At step 1505, a first plurality of profiles is retrieved. For example, control circuitry 304 may retrieve a plurality of user profiles attending a venue together. Control circuitry may determine and identify a number of users using detecting circuitry 307. Based on the determined and identified users, control circuitry may retrieve user profiles from any of web servers 430 or from a wireless communication device 406 associated with an identified user. Control circuitry 304 may retrieve the first plurality of user profiles in response to receiving a request to display seating allocations and assignments in screen 500 of FIG. 5 or screen 800 of FIG. 8.

At step 1510, a determination is made about which retrieved user profiles include a common attribute. In some embodiments, a common attribute may be determined from a preset list of prioritized attributes. For example, control circuitry 304 may iterate through the preset list of attributes and determine whether the retrieved profiles contain an attribute. The first attribute in the list that is common to retrieved profiles is the common attribute. In some embodiments, a common attribute may be determined based on correlation of the profiles to determine common attributes. For example, control circuitry 304 may correlate all attributes of the retrieved user profiles, and return a list of attributes ranked by the number of retrieved user profiles that include the attribute. Based on this ranked list, control circuitry 304 may select a common attribute. For example, control circuitry 304 may determine a common attribute based on attribute information in regions 620, 630 or 640 in FIG. 6 or regions 730 or 740 in FIG. 7.

At step 1515, a user profile distinct from the first plurality of user profiles having the common attribute is retrieved. The user profile may be selected based on detection of a new user in the venue. For example, detecting circuitry 307 may detect and identify a new user entering the venue. In response, control circuitry 304 may retrieve a user profile corresponding to the detected user from any of web servers 430 or from a wireless device 406 corresponding to the newly detected user. For example, control circuitry 304 may retrieve a distinct user profile in response to receiving a request to attend a venue from a distinct user, or in response to receiving a request to display screen 500 or display screen 800 from a distinct user.

At step 1520, values of common attributes of the retrieved profiles are correlated based on primary criteria. As referred to herein, the term criteria should be understood to mean a number or order of attributes that may be used to correlate attribute values, and a number of correlation threshold values. For example, control circuitry 304 may correlate the values of a number of common attributes using any suitable method discussed above in reference to FIG. 3. Based on the correlation, the control circuitry may determine a number of correlation scores, one for each common attribute and each user profile. For example, control circuitry 304 may correlate attribute values corresponding to attribute fields 622, 624, or 626 to compute a number of correlation scores.

At step 1525, the retrieved plurality of user profiles may be divided into clusters based on the correlation. For example, control circuitry 304 of a computer equipment may compare a correlation score for a common attribute and user profile to a threshold, and determine, based on the comparison, whether to include the associated user profile in a cluster. In some implementations, control circuitry 304 may divide the retrieved user profiles into one or more non-overlapping clusters. In some implementations, control circuitry 304 may divide the retrieved user profiles into one or more overlapping clusters.

At step 1530, a first cluster is selected from one of the clusters divided from the retrieved user profiles in step 1525. For example, control circuitry 304 may select a cluster based on the highest average of correlation scores in the cluster, or lowest variance of correlation scores in the cluster.

At step 1535, a cluster size of the first selected cluster is compared to a first threshold. In some implementations, it may be desirable to limit the maximum cluster size. For example, the venue may be composed of sub-portions that include a fixed number of seats. It may be desirable to limit the maximum cluster size to the number of seats in the sub-portion. In some implementations, it may be desirable to limit the minimum cluster size. For example, too few members of a cluster may lead to insufficient interaction among users, and accordingly, a less desirable viewing experience. If the cluster size is above the first threshold, the process proceeds to step 1540. If the cluster size is below the first threshold, the control process proceeds to step 1545. For example, control circuitry 304 may execute step 1535 and subsequent steps to select a cluster having a size that is substantially the size of a seating zone illustrated in screen 500 of FIG. 5.

At step 1540, a secondary criteria may be selected for dividing retrieved user profiles into clusters. For example, control circuitry 304 may select a different set of criteria for dividing the retrieved profiles into clusters. Control circuitry may compare a different correlation score for a different common attribute than the one used in step 1525. In some implementations, if multiple clusters were previously divided from the retrieved profiles in step 1525, a different cluster having the next smaller size, relative to the previously selected cluster, is selected. For example, control circuitry 304 may correlate attribute values corresponding to fields 632, 634, 636 or 638 to compute a number of correlation scores. Control circuitry 304 may correlate attribute values of one or more attributes in any order. For example, control circuitry 304 may compute a weighted average of correlation scores based on a genre attribute corresponding to region 620 and an actor attribute corresponding to region 630.

At step 1545, the cluster size of the first selected cluster is compared to a second threshold. If the cluster size is smaller than the second threshold, the process proceeds to step 1520. For example, the criteria used by control circuitry 304 to select the common attributes resulted in cluster sizes that are too small. If the cluster size is larger than the second threshold, the process proceeds to step 1555. For example, the criteria used by control circuitry 304 to select the common attributes resulted in an acceptable cluster size. For example, the size of a selected cluster may be substantially the size of any seating zone illustrated in FIG. 5.

At step 1555, a first seating zone is allocated based on the selected first cluster. For example, control circuitry 304 may allocate a number of seats in the venue that corresponds to a number of users associated with the selected first cluster. For example, control circuitry 304 may allocate seating zone 505 of FIG. 5 to a cluster of users with user profiles having correlated values of a genre attribute.

At step 1560, a second seating zone is selected, based on user profiles not yet allocated to a seating zone. For example, control circuitry 304 may select a different unselected cluster that resulted from division of the retrieved user profiles in step 1525. For example, control circuitry 304 may select a cluster of user profiles correlated based on an actor attribute.

At step 1562, a second seating zone is allocated based on the selected second cluster. For example, control circuitry 304 may allocate a number of seats in the venue that corresponds to a number of seats in the second selected cluster. For example, control circuitry 304 may allocate seating zone 510 of FIG. 5 to a cluster of users with user profiles having correlated values of an actor attribute.

At step 1565, seating in the first seating zone may be assigned based on users associated with the user profiles in the first selected cluster of user profiles. For example, control circuitry 304 may iteratively select a user profile from the first selected cluster, and assign a seat to the selected user profile. In some implementations, control circuitry may automatically assign the seating within the zone based on other user profile information such as seating preference information. For example, control circuitry may assign aisle seats within a seating zone to users whose user profiles indicate an aisle seating preference. If there are fewer aisle seats than users having aisle seating preferences, control circuitry may defer to other user profile information, such as status level in a membership rewards program. In some implementations, control circuitry may assign seating in response to receiving a user selection of a seat. For example, control circuitry may receive a user request indicating a seat displayed in information screen 500 discussed above in FIG. 5.

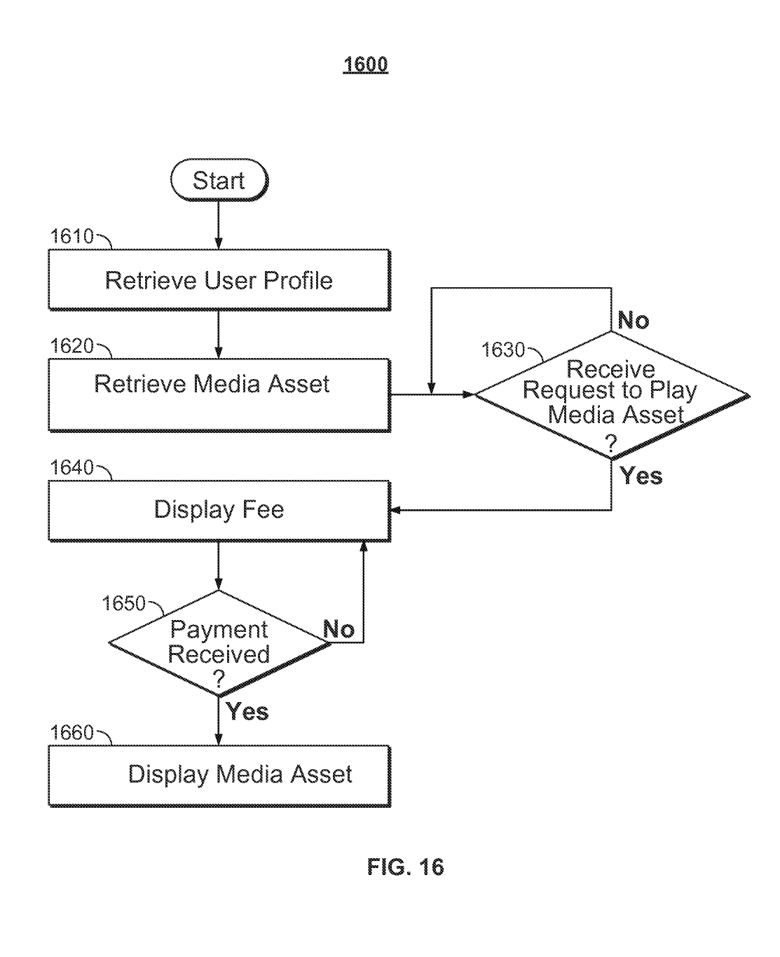

FIG. 16 illustrates a flowchart of steps for a process 1600 that may be implemented by a system for renting viewing equipment in a venue in some embodiments of the present disclosure. In some embodiments, a venue, such as an airplane, may include individual viewing apparatus at each seat. A user may be able to rent the viewing apparatus to play back a media content asset that is accessible to the user, either through subscription or available on a user device. The process may be performed by control circuitry associated with the viewing apparatus. Control circuitry 304 may execute the steps of process 1600 when generating for display, screen 1000 to enable a user to rent viewing equipment for playback of a media asset.

At step 1610, a user profile may be retrieved. In some implementations, control circuitry 304 may retrieve a user profile in response to receiving a user input indicating the user profile, for example, from an input screen (not shown). In some implementations, control circuitry 304 may retrieve a user profile in response to detecting and identifying a user by detecting circuitry 307. In some implementations control circuitry 304 may retrieve a user profile from a personal device associated with the user that is coupled to the control circuitry 304 by a communications path. For example, control circuitry 304 may detect a user or a user device associated with a user by using detecting circuitry 307 and generate for display screen 1100 illustrating one or more detected user devices and user profile information corresponding to a detected user.

At step 1620, a media asset is retrieved for playback on the viewing apparatus. In some implementations, control circuitry 304 may retrieve the program for playback by copying a file of the media asset from the personal device. In some implementations, control circuitry may stream the media asset from the device across a communications path. In some implementations, control circuitry may play back the media asset from a central media content source 416 or one of web servers 430 that are accessible to the viewing apparatus. In some implementations, control circuitry may retrieve a listing of the media assets for display. For example, region 1050 of FIG. 10 includes a listing of media assets that may be played back from a personal user device, or through an online streaming service to which the user has a subscription.

At step 1630, a determination is made whether a request to play back the media asset has been retrieved. If a request to play back a media asset has been received, the process proceeds to step 1460. Otherwise, the process polls on step 1630. The request to play back may be received in response to showing screen 1000 of FIG. 10 on a display. For example, a selection of the movie “Revenge of the Nerds” 1054 may be received. Control circuitry 304 may receive a user request to play back a media asset on the viewing apparatus.

At step 1640, a fee is displayed on the screen. For example, in FIG. 10, a series of fee options are displayed in region 1030. Different fees are offered for playback in standard definition versus high definition. Control circuitry may display a fee to the user to play back a media asset on the viewing apparatus.

At step 1650, a determination is made whether a payment has been received. If a payment has been received, the process proceeds to step 1660. Otherwise, the process polls on step 1650. For example, control circuitry may determine whether an input has been received as a selection of one of options 1032, 1034 and 1036 from display screen 1000 of FIG. 10, indicating payment of the fee displayed in step 1640.

At step 1660, the media asset is displayed on the viewing apparatus. For example, control circuitry 304 may play back the media asset via a display on the viewing apparatus. For example, the media asset may be played back in region 1220 of FIG. 12.

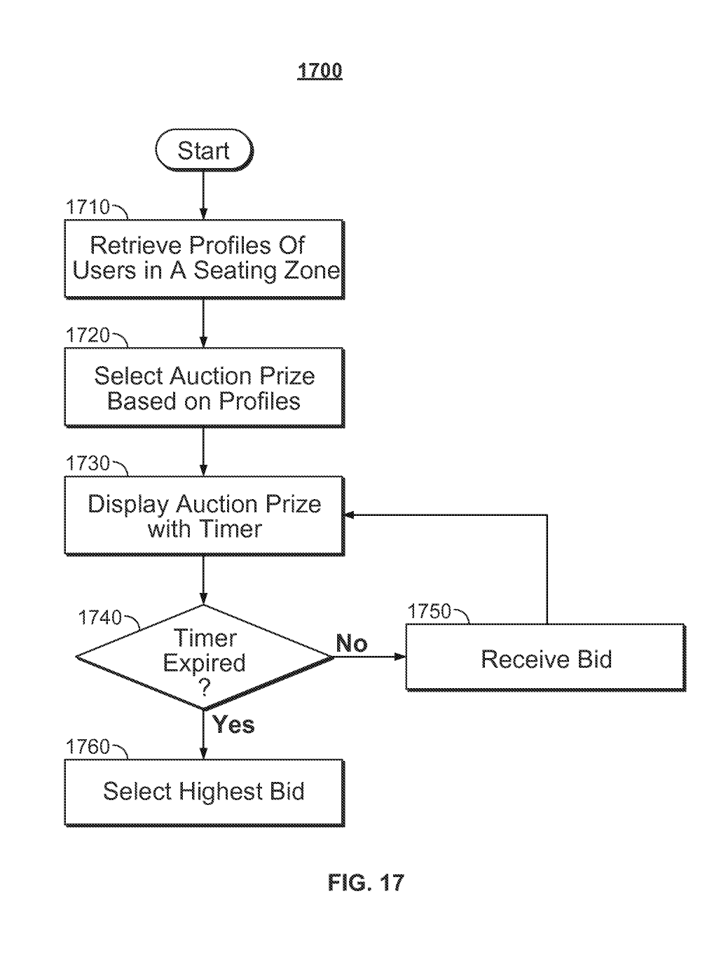

FIG. 17 illustrates a flowchart of steps for a process 1700 that may be performed by a system for holding auction activities in a viewing venue in some embodiments of the present disclosure. The process may be performed by control circuitry associated with the viewer apparatus. Control circuitry 304 may execute the steps of process 1700 when generating for display, screen 1300, which enables interactive activities among users within a venue. For example, control circuitry 304 may enable interactive activities among users within an allocated seating zone.

At step 1710, a user profile corresponding to users seated in a seating zone is retrieved. For example, control circuitry 304 may determine the number of seated users using detecting circuitry 307. The control circuitry may retrieve user profiles corresponding to the users seated in the seating zone, such as any seating zone illustrated in screen 500 of FIG. 5.

At step 1720, one or more auction prizes is selected based on user profile information. For example, control circuitry 304 may select a free meal ticket to a restaurant determined to be frequented by a majority of the seated users. Control circuitry 304 may generate for display regions 1322 or 1324 of screen 1300 of FIG. 13 show information about selected auction prizes.

At step 1730, an auction timer is displayed on the screen with an indicator of the one or more auction prizes. For example, in reference to display screen 1300 of FIG. 13, control circuitry 304 may generate, for display in screen 1300, auction prize indicators for a free meal voucher 1322 and a free drink voucher 1324. Control circuitry 1300 may also operate a countdown auction timer and generate for display the auction timer in region 1325.

At step 1740, a determination may be made whether the auction timer has expired. If the auction timer has not expired, the process proceeds to step 1750. If the timer has expired, the process proceeds to step 1760. For example, control circuitry 304 may determine whether the auction timer has expired. Control circuitry 304 may iteratively update the generation of display 1300 to account for the progression of the auction timer.

At step 1750, bids are received for the auction prizes. The bids may be entered via form region 1332 of FIG. 13. For example, control circuitry 304 may receive inputs from users, indicating a bid amount for the auction prize. The process proceeds to step 1730.

At step 1760, the highest bid is selected, and the auction prize is awarded to the winner. For example, control circuitry 304 may determine the user profile associated with the winning bid, and deliver the auction prize to the user. In some embodiments, there may be more than one auction winner. For example, control circuitry 304 may select the number of highest bids equal to the number of auction prizes and determine a winner for each of the auction prizes based on the rank of bid amounts. Control circuitry may next deliver the bids to the winners of the auction.

It should be understood that the above steps of the flowcharts of FIGS. 15, 16 and 17 may be executed or performed in any order or sequence not limited to the order and sequence shown and described in the figure. Also, some of the above steps of the flowcharts of FIGS. 15, 16 and 17 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for creating a seating arrangement in a venue having a plurality of seats, the method comprising:
retrieving a plurality of user profiles associated with users attending the venue together;
determining which of the retrieved plurality of user profiles include a common attribute;
correlating common attribute values of the retrieved user profiles that include the common attribute;
selecting a cluster of user profiles from the retrieved plurality of user profiles based on the correlation of the common attribute values;
allocating a first number of the plurality of seats in a proximate relationship to a first seating zone, wherein the first number corresponds to a size of the selected cluster of user profiles;
allocating a remaining number of the plurality of seats that are not allocated to the first seating zone to a second seating zone; and
assigning each of the plurality of seats in the first seating zone to the users associated with the user profiles in the selected cluster.

2. The method of claim 1, wherein the assigning of a seat in the first seating zone is performed automatically.

3. The method of claim 1 further comprising:
displaying a visual representation of the first and second seating zones to a user;
receiving a request from the user for a seating assignment;
determining that a user profile associated with the requesting user corresponds to the first zone; and
restricting the seating assignment of the user to a seat in the first seating zone.

4. The method of claim 1 wherein the common attribute is one of:
viewing preferences, demographic information comprising an age, a gender, a race, a profession, a marital status, or a number of dependents.

5. The method of claim 1 further comprising:
retrieving a user profile distinct from the plurality of user profiles that include the common attribute;
determining whether the distinct user profile includes the common attribute;
in response to determining that the distinct user profile includes the common attribute:
correlating a common attribute value of the distinct user profile and the common attribute values of the plurality of user profiles that include the common attribute;
adding the distinct user profile to the selected cluster of user profiles based on the correlation;
assigning a seat to a user associated with the distinct user profile in the first seating zone;
adjusting the first number of allocated seats of the first seating zone based on the correlation of the common attribute value of the distinct user profile and the common attribute values of the plurality of user profiles.

6. The method of claim 1 wherein the venue is a theatre for presenting a common media asset to a plurality of users seated in the venue, each of the user profiles includes patron information about an associated user, and the common attribute includes patron information, the method further comprising:
assigning a seat to a user based on the patron information.

7. The method of claim 1 wherein:
each seat within the venue includes a viewing apparatus,
each user profile contains viewer preference information comprising parental control information, a favorite actor, a favorite genre, favorite title, favorite director, or favorite character, and the common attribute includes viewer preference information, and
the first seating zone is associated with viewer preference information of a user,
the method further comprising:
receiving a request from a user for a seating assignment;
determining that the viewer preference information of the user corresponds to the common attribute;
in response to the determining, restricting assignment of a seat to the user to a seat in the first seating zone,
wherein the first seating zone is associated with the viewer preference information of the user.

8. The method of claim 7 wherein each user profile is a media guide user profile.

9. The method of claim 7, further comprising:
determining a media asset for display in the first seating zone based on the common attribute of the cluster of profiles corresponding to the first seating zone.

10. The method of claim 8, wherein the venue is a transportation craft.

11. A system for creating a seating arrangement in a venue having a plurality of seats, the system comprising:
control circuitry configured to:
retrieve a plurality of user profiles associated with users attending the venue together;
determine which of the retrieved plurality of user profiles includes a common attribute;
correlate common attribute values of the retrieved user profiles that include the common attribute;
select a cluster of user profiles from the retrieved plurality of user profiles based on the correlation of the common attribute values;
allocate a first number of the plurality of seats in a proximate relationship to a first seating zone, wherein the first number corresponds to a size of the selected cluster of user profiles;
allocate a remaining number of the plurality of seats that are not allocated to the first seating zone to a second seating zone; and
assign each of the plurality of seats in the first seating zone to the users associated with the user profiles in the selected cluster.

12. The system of claim 11, wherein the assigning of a seat in the first seating zone is performed automatically.

13. The system of claim 11 wherein the control circuitry is further configured to:
generate for display a visual representation of the first and second seating zones to a user;
receive a request from the user for a seating assignment;
determine that a user profile associated with the requesting user corresponds to the first zone; and
restrict the seating assignment of the user to a seat in the first seating zone.

14. The system of claim 11 wherein the common attribute is one of:
viewing preferences, demographic information comprising an age, a gender, a race, a profession, a marital status, or a number of dependents.

15. The system of claim 11 wherein the control circuitry is further configured to:
retrieve a user profile distinct from the plurality of user profiles that includes the common attribute;
determine whether the distinct user profile includes the common attribute;
in response to determining that the distinct user profile includes the common attribute:
correlate a common attribute value of the distinct user profile and the common attribute values of the plurality of user profiles that include the common attribute;
add the distinct user profile to the selected cluster of user profiles based on the correlation;
assign a seat to a user associated with the distinct user profile in the first seating zone;
adjust the first number of allocated seats of the first seating zone based on the correlation of the common attribute value of the distinct user profile and the common attribute values of the plurality of user profiles.

16. The system of claim 11 wherein the venue is a theatre for presenting a common media asset to a plurality of users seated in the venue, each of the user profiles includes patron information about an associated user, and the common attribute includes patron information, and the control circuitry is further configured to:
assign a seat to a user based on the patron information.

17. The system of claim 11 wherein:
each seat within the venue includes a viewing apparatus,
each user profile contains viewer preference information comprising parental control information, a favorite actor, a favorite genre, favorite title, favorite director, or favorite character, and the common attribute includes viewer preference information, and
the first seating zone is associated with the viewer preference information of a user,
and the control circuitry is further configured to:
receive a request from a user for a seating assignment;
determine that the viewer preference information of the user corresponds to the common attribute;
in response to the determining, restrict assignment of a seat to the user to a seat in the first seating zone,
wherein the first seating zone is associated with the viewer preference information of the user.

18. The system of claim 17 wherein each user profile is a media guide user profile.

19. The system of claim 17, wherein the control circuitry is further configured to:
determine a media asset for display in the first seating zone based on the common attribute of the cluster of profiles corresponding to the first seating zone.

20. The system of claim 18, wherein the venue is a transportation craft.

21-30. (canceled)
